(19) United States
(12) Patent Application Publication
(10) Pub. No.: US 2026/0055010 A1
(43) Pub. Date: Feb. 26, 2026

(54) Extracting Carbon Dioxide from Seawater Using Bubble Reactors

(71) Applicant: Captura Corp, Pasadena, CA (US)

(72) Inventors: Chengxiang Xiang, San Marino, CA (US); Ibadillah Ardhi Digdaya, Whittier, CA (US); Vahid Gholami Ghamsari, Pasadena, CA (US); Zhiyuan Qi, Pasadena, CA (US)

(73) Assignee: Captura Corp, Pasadena, CA (US)

(21) Appl. No.: 19/056,493

(22) Filed: Feb. 18, 2025

Related U.S. Application Data
(60) Provisional application No. 63/685,043, filed on Aug. 20, 2024.

(51) Int. Cl. C02F 1/20; C02F 1/68; C02F 103/08

(52) U.S. Cl. CPC C02F 1/20; C02F 1/68; C02F 2103/08; C02F 2301/063

(57) ABSTRACT

In a general aspect, carbon dioxide (CO₂) is extracted from seawater. In some aspects, a direct ocean capture (DOC) method includes receiving, in an interior volume of a vessel, acidified seawater that includes dissolved carbon dioxide. A carrier gas is bubbled through the acidified seawater in the interior volume of the vessel, thereby causing the carrier gas to extract a portion (e.g., at least 80%) of the carbon dioxide from the acidified seawater. A product gas that includes the extracted carbon dioxide is communicated from the interior of the vessel. The product gas may include, for example, at least 4% carbon dioxide.

### CROSS-REFERENCE TO RELATED APPLICATIONS

This application claim priority to U.S. Provisional Patent Application No. 63/685,043, filed on Aug. 20, 2024 and titled “Extracting Carbon Dioxide From Ocean Water Using Bubble Reactors”. The priority application is hereby incorporated by reference.

### BACKGROUND

The following description relates to extracting carbon dioxide from seawater using bubble reactors.

Extracting carbon dioxide (CO₂) from seawater can serve many environmental, industrial, and scientific purposes. For example, CO₂ extraction from seawater can aid in mitigating climate change by restoring the ocean capacity to absorb atmospheric CO₂ and mitigating ocean acidification. The ocean is one of the world's largest carbon sinks and holds approximately fifty times more carbon than the atmosphere. Additionally, the ocean absorbs approximately 30% of annual human-caused CO₂ emissions. Furthermore, CO₂ extraction may facilitate environmental monitoring and scientific investigations, providing insights into carbon cycling, oceanography, climate science, and marine biology.

### DESCRIPTION OF DRAWINGS

FIG. 1A is a schematic diagram of an example direct ocean capture (DOC) system for removing CO₂ from seawater.

FIG. 1B is a detailed schematic diagram of an example DOC system for removing CO₂ from seawater.

FIG. 2 is a plan view of an example DOC vessel illustrating interior components thereof.

FIG. 3 is a plan view of an example CO₂ removal vessel illustrating fluid regions formed therein.

FIG. 4 is a plan view of an example DOC vessel illustrating placement of diffusers and float valves therein.

FIG. 5 is a perspective view of an example DOC vessel illustrating external features thereof.

FIG. 6 is a schematic diagram of an example cross-flow CO₂ system.

FIG. 7 is a plan view of an example cross-flow DOC vessel illustrating interior features thereof.

FIG. 8 is a plan view of an example cross-flow DOC vessel illustrating compartmentalized flow therethrough.

FIG. 9A is a block diagram of an example DOC system in a first mode of operation.

FIG. 9B is a block diagram of an example multi-stage DOC system in the first mode of operation.

FIG. 10A is a block diagram of an example DOC system in a second mode of operation.

FIG. 10B is a block diagram of an example DOC system in a third mode of operation.

FIG. 11 is a graph illustrating an example of CO₂ removal efficiency and CO₂ purity according to the first mode of operation.

FIG. 12 is a graph illustrating an example of CO₂ removal efficiency and CO₂ purity according to the second mode of operation.

FIG. 13 is a graph illustrating an example of CO₂ extraction efficiency as a function of vacuum pressure.

FIG. 14 is a graph illustrating an example of CO₂ extraction efficiency as a function of water depth.

FIG. 15 is a graph illustrating an example of CO₂ removal efficiency and CO₂ purity according to a third mode of operation.

FIG. 16A is a flow diagram illustrating an example process for removal of CO₂ from seawater according to the first mode of operation (vacuum mode).

FIG. 16B is a flow diagram illustrating an example process for removal of CO₂ from seawater according to the second mode of operation (combo mode).

FIG. 16C is a flow diagram illustrating an example process for removal of CO₂ from seawater according to the third mode of operation (air sparging mode).

### DETAILED DESCRIPTION

In some aspects of what is described here, a system for carbon dioxide (CO₂) removal in a direct ocean capture (DOC) system includes a vessel configured to receive a carrier gas to remove CO₂ from seawater. In some instances, the vessel receives the carrier gas from the bottom of the vessel and the acidified seawater from the top of the vessel. In some implementations, the carrier gas may be introduced by using air gas diffusers or other mechanisms, and the carrier gas bubbles up through the acidified seawater in the vessel. In certain examples, the carrier gas bubble dimensions in the reactor may range from a few hundreds of microns to a few millimeters; bubbles of other sizes may be generated in some implementations. The DOC system may include a control system with fluid control components (e.g., vacuum pump, water effluent pump, air gas diffuser, float valves, etc.) and subsystems configured to control liquid flow rate, mass flow rate, water pressure, water temperature, pH, gas pressure, or other properties of seawater and carrier gas in the vessel for optimized or otherwise improved residence time and linear flow velocity of the seawater and the carrier gas. In some instances, the vessel may include a vacuum source in addition to the carrier gas.

In some implementations, the systems and techniques described here can provide technical advantages and improvements. For example, the systems and techniques may provide high surface-to-volume ratios for separation and collection of gaseous CO₂ from its aqueous forms. The systems and techniques described here may, in some instances, enable efficient CO₂ stripping in a DOC system; have low energy demand; reduce levelized cost of CO₂ from the DOC system; reduce operational maintenance; provide tunable purity of CO₂ output; and improve energy efficiency of a DOC system. In some instances, the systems and techniques described here may also reduce competition for useful land; allow access to oceanic CO₂ storage sites; can be scalable; and produce valuable CO₂ streams offshore for fuel and chemical synthesis; and allow a direct reversal of ocean acidification caused by anthropogenic CO₂ emissions. In some cases, a combination of these and potentially other advantages and improvements may be obtained.

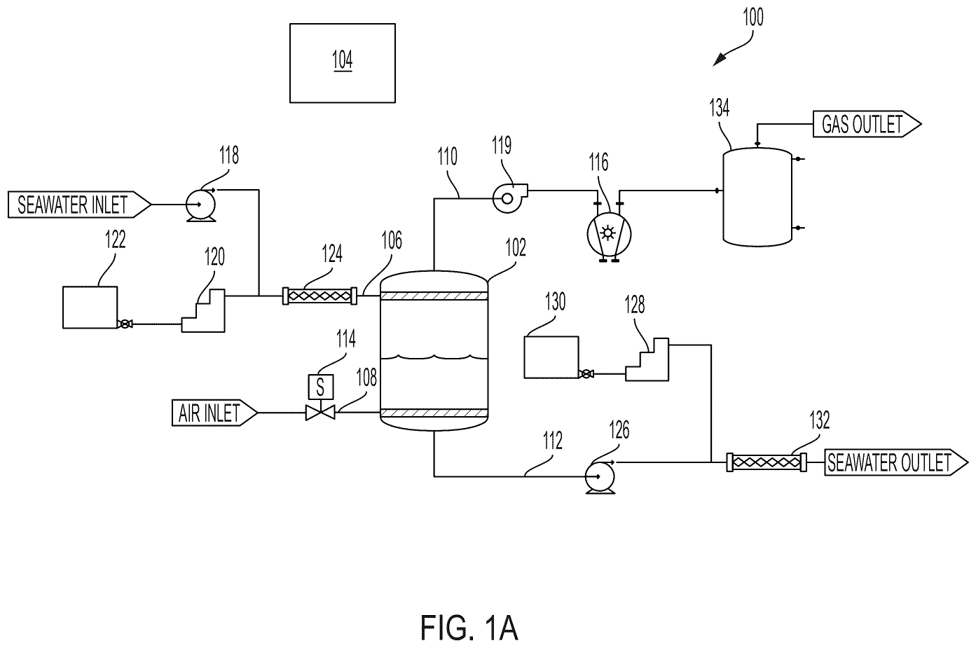

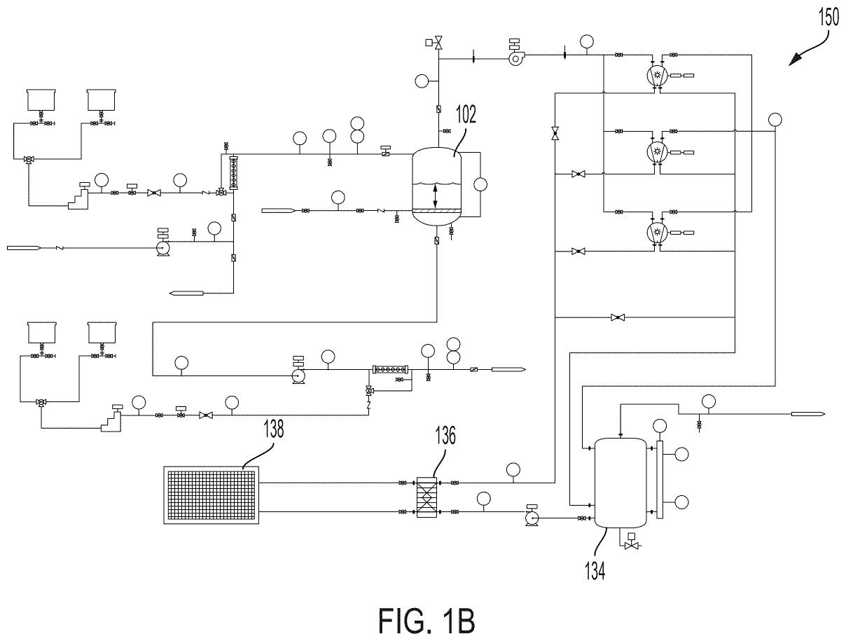

FIG. 1A is a schematic diagram of an example direct ocean capture (DOC) system 100 for removing CO₂ from seawater. The example DOC system 100 illustrated in FIG. 1 includes one or more DOC vessels 102 and a control system 104. Each of the one or more DOC vessels 102 includes a first inlet 106 for CO₂-rich seawater and a second inlet 108 for receiving a carrier gas. Additionally, the one or more DOC vessels 102 includes a first outlet 110 for removal of a product gas from the DOC vessel 102 and a second outlet 112 for removal of CO₂-lean seawater from the DOC vessel. The seawater received by DOC vessel 102 may be or include water from one or more of a variety of sources, for example, from an ocean, a sea, or another source of CO₂-rich water. The example DOC system 100 may include additional or different features, and the components of the DOC system may operate as described with respect to FIG. 1A-1B or in another manner.

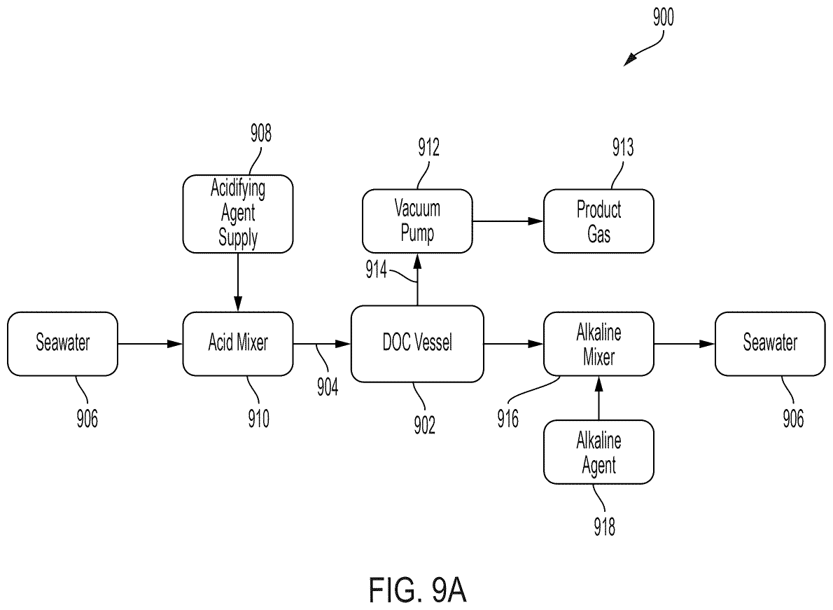

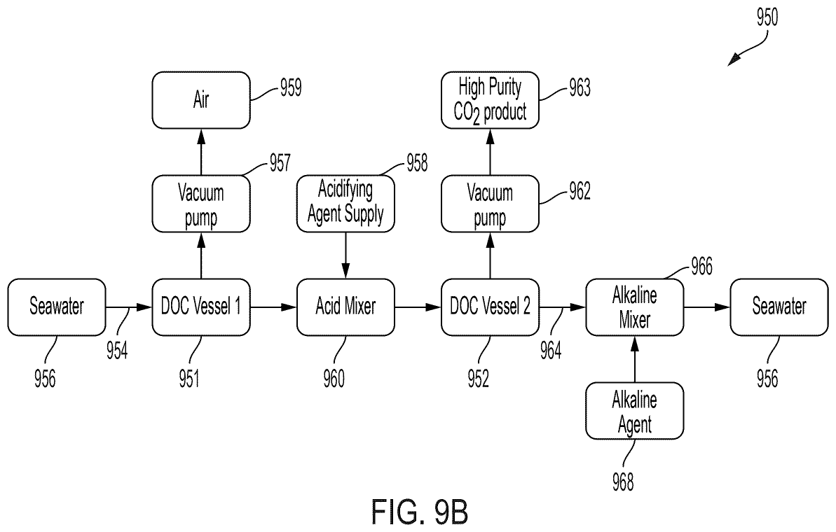

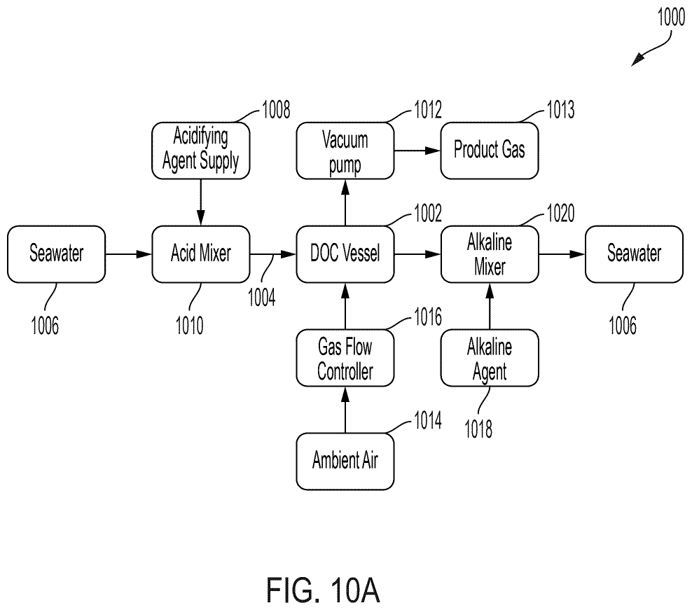

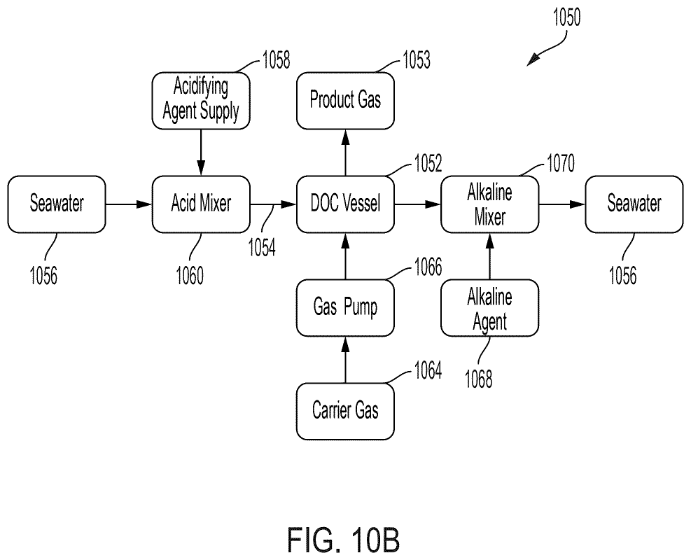

In the example shown, the DOC vessel 102 is configured to bubble a carrier gas through acidified seawater to remove CO₂ from the seawater. The DOC vessel 102 can be adapted to various modes of operation, such as, for example, an air sparging mode (e.g., as described with respect to FIGS. 10B, 15 and 16C, or otherwise), a vacuum mode (e.g., as described with respect to FIGS. 9A, 9B, 11 and 16A), a combo mode (e.g., as described with respect to FIGS. 10A, 12, 13 and 16B), or potentially other modes of operation. Multiple distinct modes of operation can be configured to achieve target efficiency, purity and other performance metrics. For instance, certain example implementations of air sparging modes, vacuum modes and combo modes describe here each cause the carrier gas to extract at least 80% of the carbon dioxide from the acidified seawater, and produce a product gas comprising at least 4% carbon dioxide. In some cases, a DOC vessel 102 can be operated in a manner that achieves a purity that approaches a thermodynamic limit for the given operating conditions.

In some examples, the features, components, operating parameters and other aspects of the DOC system 100 can be modified or configured for deployment in one or more specified modes of operation. For instance, in a given deployment, the DOC system 100 may be configured for one mode of operation. In some cases, in a given deployment, the DOC system 100 may be configured for multiple modes of operation. One or more modes of operation may be selected for a given deployment based on a number of factors, such as, for example, a CO₂ purity target or a target energy usage. In some cases, vacuum mode may be selected for a deployment in which a high CO₂ purity target is desired. Advantages of vacuum mode may include, for example, increased efficiency and increased purity. In some cases, air sparging mode may be selected for a deployment in which low energy consumption is required and CO₂ purity may be lower. Advantages of air sparging mode may include, for example, lower cost, increased energy efficiency (e.g., no need to operate vacuum pump), and decreased energy consumption. In some cases, combo mode may be selected for a deployment in which both CO₂ purity and energy consumption need to be optimized. Advantages of combo mode may include, for example, increased efficiency, increased purity, and decreased energy consumption compared to vacuum mode.

In the example shown, the DOC vessel 102 is configured to operate with minimal or no use of packing material or solid interface structures in the interior of the vessel. Instead, the DOC vessel 102 can increase the residence time of carrier gas in the acidified seawater by causing the carrier gas to form bubbles or foam in the acidified seawater. Minimizing or even eliminating the use of packing material in the DOC vessel 102 can provide advantages, particularly for processing seawater. For instance, seawater can include debris and impurities that could clog or damage packing material, which would typically degrade performance and increase cost and maintenance over time.

In some implementations, the DOC vessel 102 is configured to receive CO₂-rich seawater containing dissolved CO₂ gas. In some instances, seawater may be acidified before being received at the DOC vessel 102. For example, the pH of the seawater may be reduced from an initial value (e.g., 8.1 or another value) to a lower value before the seawater is received at first inlet 106 of the DOC vessel 102. For example, the pH value of the acidified seawater may be equal to or greater than 6, 5, 4, or another value. In certain instances, the seawater may be screened, filtered, heated, or processed in another manner prior to the acidification process. The acidified seawater may be introduced into the DOC vessel, where it comes into contact with the carrier gas that is introduced through the second inlet 108.

In some implementations, the acidification process includes mixing an acidic solution with the processed seawater. In some instances, the acidic solution includes hydrochloric acid (HCl), or other types of acid. In some instances, the acidic solution used to obtain the acidified seawater may be generated onsite as part of the example DOC system 100 using, for example, an electrodialysis process or obtained in another manner. In some implementations, the acidic solution introduced to the seawater during the acidification process can react with dissolved inorganic carbon in forms of bicarbonate and carbonate in the seawater; and can convert the dissolved inorganic carbon to aqueous CO₂ and increase the concentration of the dissolved aqueous CO₂ in the acidified seawater. In some instances, other processes or other treatment to the seawater to increase the concentration of the dissolved CO₂ gas may be used.

In some implementations, the carrier gas may be ambient air or another gas such as, for example, oxygen (O₂), hydrogen (H₂), nitrogen (N₂), helium (He), argon (Ar), carbon monoxide (CO). In various implementations, the carrier gas may be supplied from an external source such as, for example, a gas tank to the second inlet 108 of the DOC vessel 102. In other implementations, the carrier gas may be ambient air introduced to the second inlet 108 of the DOC vessel 102 via, for example, a check valve 114. In still other implementations, the carrier gas may be dissolved in the acidified seawater.

In some aspects of operation, the DOC vessel 102 may operate by the application of Henry's Law, which states that the amount of a dissolved gas in a liquid is proportional at equilibrium to the partial pressure of the gas above the liquid. Mathematically, Henry's Law is stated as:

$${H}_{s}^{cp} = \frac{{c}_{a}}{p}$$

Where cₐ is the molar concentration of an aqueous phase of a dissolved gas, and p is the partial pressure of that gas in the gas phase.

$${H}_{s}^{cp}$$

represents the “Henry's solubility constant” of the gas. Thus, as the partial pressure of a gas decreases, the molar concentration of the aqueous phase of the gas will also decrease.

In some implementations, the control system 104 is communicably coupled to one or more control units (e.g., water pumps, flow sensor, vacuum pumps, pressure sensor, etc.) to adjust the pH and the flow rate of the seawater into the DOC vessel 102, and the flow rate of the carrier gas or vacuum (e.g., partial pressure) applied to the DOC vessel 102. In some instances, the control system 104 may be coupled to other components of the DOC system 100 to control other parameters. For example, the control system 104 may be coupled to a gas chromatograph or CO₂ sensor configured to analyze and evaluate the CO₂ concentration collected from the DOC vessel 102, a pH sensor configured to measure the pH values of the seawater, and other components or devices of the example DOC system 100. In some implementations, the control system 104 includes one or more computer processors, a memory unit, an input/output interface, or other components that allow the communication of the control system 104 with other components of the example DOC system 100, determine control parameter values of the components of the example DOC system 100, and optimize the CO₂ removal performance of the example DOC system 100. In some instances, the control system 104 may be configured for performing other functions.

In various implementations, the example DOC system 100 includes a seawater intake system 118 that is configured to supply seawater to the DOC vessel 102 via the first inlet 106. In various implementations, the seawater intake system 118 may be, for example, a centrifugal pump, a reciprocal pump, a turbine pump, or another type of pump. In various implementations, the seawater intake system 118 may receive the seawater from the surface of the body of water or water from any depth below the surface of the water. An acid pump 120 is configured to feed the acidic solution to the seawater during the acidification process. In various implementations, the acid pump 120 is coupled to an acid supply 122 and an acid mixer 124. In various implementations, the acid supply 122 may be, for example, an acid tank and the acid mixer 124 may be, for example, a static mixer that is configured to mix the acidic solution with the seawater supplied by the seawater intake system 118. In such implementations, the acid mixer 124 is coupled to the first inlet 106. In some implementations, the acid mixer may not be needed.

In various implementations, a vacuum pump 116 is coupled to the first outlet 110 of the DOC vessel 102. The vacuum pump 116 may be, for example, a liquid ring vacuum pump; however, in other implementations, the vacuum pump 116 may be, for example, a rotary vane vacuum pump, a diaphragm vacuum pump, a scroll vacuum pump, a turbomolecular vacuum pump, or another type of vacuum pump. In various implementations, one or more booster pumps 119 are coupled to the vacuum pump 116 and to the first outlet 110 of the DOC vessel 102. The one or more booster pumps 119 are configured to provide additional flow of product gas to the vacuum pump 116 so as to generated lower pressures in the DOC vessel 102.

In various implementations, the example DOC system 100 includes a discharge pump 126 that is configured to remove CO₂-lean seawater from the DOC vessel via the second outlet 112. In some implementations, a gravity drain may be used to remove CO₂-lean seawater by adjusting the height or altitude of the DOC vessel relative to the body of water to counteract the negative pressure caused by the applied vacuum, eliminating the need for the discharge pump. In various implementations, the discharge pump 126 may be, for example, a centrifugal pump, a reciprocal pump, a turbine pump, or another type of pump. In various implementations, the discharge pump 126 may discharge the CO₂-lean seawater to the surface of the body of water or water to any depth below the surface of the water. In the example shown, an alkaline pump 128 is configured to feed an alkaline solution to the CO₂-lean seawater. In various implementations, the alkaline pump 128 is coupled to an alkaline supply 130 and an alkaline mixer 132. In various implementations, the alkaline supply 130 may be, for example, an alkaline tank and the alkaline mixer 132 may be, for example, a static mixer that is configured to mix the alkaline solution with the CO₂-lean seawater supplied from the DOC vessel 102. In such implementations, the alkaline mixer 132 is coupled to the discharge pump 126.

In some instances, multiple DOC vessels 102 in the example DOC system 100 may be connected in series. For example, the seawater can go through a series of DOC vessels 102 until a certain condition is met (e.g., for example a concentration of the dissolved CO₂ gas in the seawater is below a predetermined threshold limit). In some instances, the acidified seawater can be processed in parallel by simultaneously operating multiple DOC vessels 102 to improve production. In some instances, a subset of DOC vessels 102 may be connected in series, and multiple subsets of DOC vessels 102 may be connected in parallel. The multiple DOC vessels 102 may include different types of carrier gases. In some instances, the multiple DOC vessels 102 may operate under different conditions (e.g., different pH values, pressure, flow rate, flow direction, etc.). In some instances, output of the example DOC system 100 includes the acidified seawater with a reduced concentration of the dissolved CO₂ gas (CO₂-lean seawater). The acidified seawater from the second outlet 112 of the DOC vessel 102 may be neutralized by injecting an alkaline solution (e.g., sodium hydroxide NaOH) to increase its pH value during an alkalinization process prior to being returned to the body of water. In some instances, the CO₂ gas collected from the DOC vessels 102 may be collected for later processing.

FIG. 1B is a detailed schematic diagram of an example DOC system 150 for removing CO₂ from seawater. As illustrated in FIG. 1B, multiple vacuum pumps 116 may be coupled in series or parallel to the first outlet 110 of the DOC vessel 102. In various implementations, a first set of the multiple vacuum pumps may be coupled in series to the first outlet 110 of the DOC vessel 102 and a second set of the multiple vacuum pumps 116 may be connected to the first outlet 110 of the DOC vessel 102. In various implementations, the vacuum pumps 116 supply the product gas to a knockout pot 134. The knockout pot is coupled to a heat exchanger 136, which is thermally exposed to a chiller 138. In various implementations, a refrigerant such as, for example, water, is circulated between the heat exchanger 136 and the chiller 138. In some implementations, seawater may be used as the coolant flowing through the heat exchanger. Product gas is circulated from the knockout pot 134 to the heat exchanger 136 to be thermally exposed to the refrigerant. Such thermal exposure causes a loss of heat and a reduction of temperature of the product gas. The reduction of temperature of the product gas causes water vapor present in the product gas to condense and collect as a liquid in the knockout pot 134. Removal of water vapor from the product gas increases the percentage of CO₂ present in the product gas.

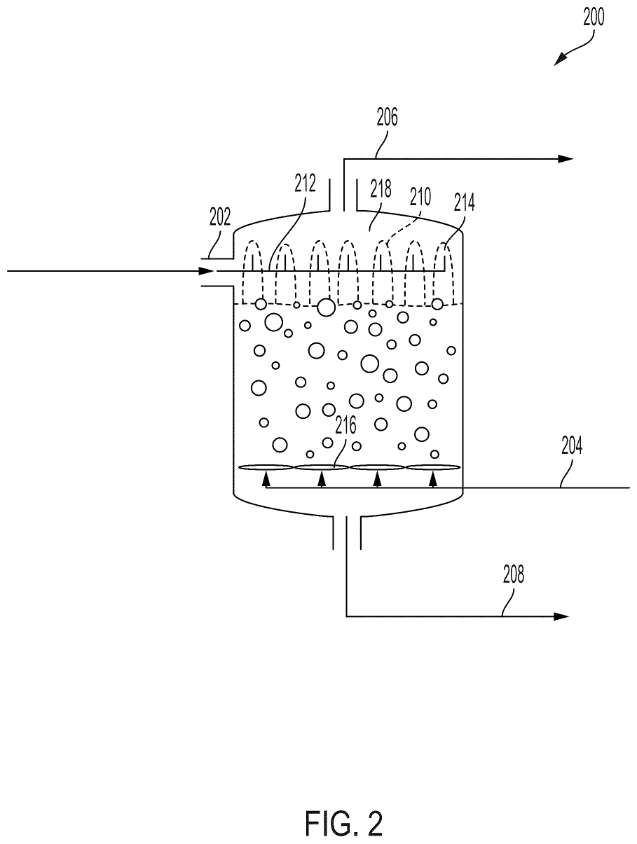

FIG. 2 is a plan view of an example DOC vessel 200 illustrating interior components thereof. In various implementations, the example DOC vessel 200 may be the DOC vessel 102 illustrated in FIGS. 1A-1B or another DOC vessel. The example DOC vessel includes a first inlet 202 for receiving CO₂-rich seawater and a second inlet 204 for receiving carrier gas. In various implementations the first inlet 202 may be the first inlet 106 or another inlet. The second inlet 204 may be the second inlet 108 or another inlet. The example DOC vessel 200 includes a first outlet 206 for removal of product gas from the DOC vessel 200 and a second outlet 208 for removal of CO₂-lean seawater from the example DOC vessel 200. In various implementations, the first outlet 206 may be the first outlet 110 or another outlet and the second outlet 208 may be the second outlet 112 or another outlet.

The example DOC vessel 200 includes a liquid distributor 210 that is coupled to the first inlet 202. The liquid distributor 210 is configured to distribute the introduction of CO₂-rich seawater across a transverse cross-sectional area of the example DOC vessel 200. In various implementations, the liquid distributor 210 includes a conduit system 212 that is coupled to the first inlet 202. In various implementations, the conduit system 212 may be formed of, for example, polyvinylchloride (PVC), polyurethane, polystyrene, or another suitable non-corrosive metallic or non-metallic material. In various implementations, a plurality of outlets 214 are formed along a length of the conduit system 212 for introduction of CO₂-rich seawater to the interior of the example DOC vessel 200. In various implementations, the outlets 214 may include ports, nozzles, sprayers, shower heads, or other type of outlet to distribute the CO₂-rich seawater within the example DOC vessel 200. In various implementations, the liquid distributor 210 is disposed in a top region of the example DOC vessel 200 where “top” and “bottom” are defined by the direction of gravity. The CO₂-rich seawater introduced by the liquid distributor 210 is collected in a bottom region of the example DOC vessel 200.

The example DOC vessel 200 includes one or more gas diffusers 216 disposed in the bottom region of the example DOC vessel 200 and coupled to the second inlet 204. In various implementations, the one or more gas diffusers 216 may be coupled to a gas manifold that is, in turn, coupled to the second inlet 204. In various implementations, the one or more gas diffusers 216 are configured to facilitate the generation of bubbles and bubbling of carrier gas through the accumulated CO₂-rich seawater. In various implementations, the one or more gas diffusers 216 may include, for example, porous diffusers (such as porous plate diffusers), porous membranes, injector nozzles, static mixers, or another type of diffuser. The one or more gas diffusers 216 introduce carrier gas to the accumulated CO₂-rich seawater. The carrier gas forms bubbles of various sizes in the seawater. Bubbling the carrier gas through the CO₂-rich seawater reduces the partial pressure of CO₂ in a head space 218 above the seawater and causes the CO₂ dissolved in the seawater to be extracted from the seawater. A product gas, which is a mixture of extracted CO₂, the carrier gas, and other gases extracted from the seawater accumulates in the head space 218. The product gas is communicated from the example DOC vessel 200 by a first outlet 206. CO₂-lean seawater that remains in the bottom region of the example DOC vessel 200 is removed via the second outlet 208.

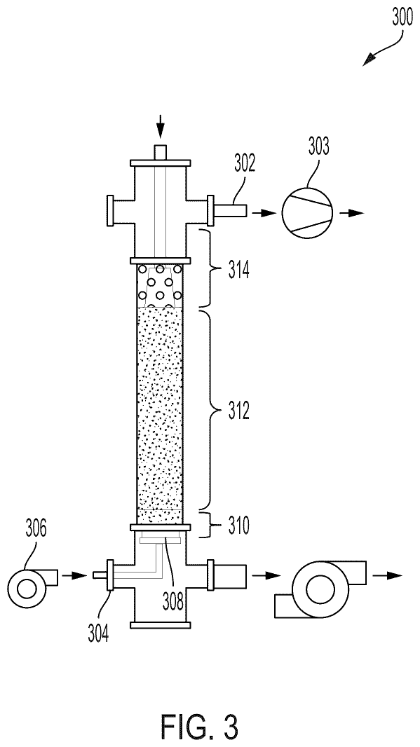

FIG. 3 is a plan view of an example DOC vessel 300 illustrating fluid regions formed therein. In various implementations, the example DOC vessel 300 may be the DOC vessel 200, illustrated in FIG. 2, the example DOC vessel 102 illustrated in FIG. 1, or another DOC vessel. In various implementations, a first outlet 302 is coupled to a vacuum pump 303. In various implementations, the first outlet 302 may be the first outlet 110 or another outlet and the vacuum pump may be the vacuum pump 116 or another vacuum pump. A first inlet 304 is coupled to a source of CO₂-lean carrier gas such as, for example, ambient air, H2, O2, N2, or He. In various implementations a blower 306 may be used to inject the carrier gas into the DOC vessel 300.

The carrier gas is introduced to the interior of a bottom region of the DOC vessel via a gas diffuser 308. In various implementations, the gas diffuser 308 may be the one or more gas diffusers 216 illustrated in FIG. 2 or another type of diffuser. The gas diffuser 308 facilitates the formation of microbubbles in the acidified seawater present in the DOC vessel 300. In various implementations, the microbubbles may range in size from a few millimeters in diameter to a few centimeters in diameter. The carrier gas is then bubbled through the seawater. The interaction between the carrier gas microbubbles and the seawater creates a foam in a foam region 312, where the volumetric composition of the seawater/carrier gas mixture is typically, on average majority (greater than 50%) carrier gas; however, this fraction may vary depending on the CO₂ purity target and the applied vacuum conditions. In various implementations, the foam region 312 contains high density carrier gas bubbles. A bubble region 310 forms below the foam region 312. In the bubble region 310, the volumetric composition of the seawater/carrier gas mixture typically, on average, includes a lower fraction of carrier gas than the foam region 312, which results in the formation of lower density carrier gas bubbles. In various implementations, the bubble region 310 forms below the foam region 312 and above the gas diffuser 308 in the DOC vessel 300. In various implementations, formation of the bubble region 310 and the foam region 312 increases interaction between the seawater and the carrier gas and increases the gas/liquid exchange area between the dissolved CO₂ in the seawater and the carrier gas within DOC vessel 300.

Bubbling the carrier gas through the CO₂-rich seawater reduces a partial pressure of the CO₂ in a head space 314 in the DOC vessel 300. In the example shown in FIG. 3, the head space 314 is defined above the foam region 312. Reducing the CO₂ partial pressure in the head space 314 causes aqueous CO₂ that is dissolved in the seawater to be extracted from the seawater in a gaseous phase. The extracted CO₂ accumulates in the head space 314 in the top region of the DOC vessel 300 along with the carrier gas. The accumulated mixture of the carrier gas with the extracted CO₂ creates a product gas. The product gas is communicated from the DOC vessel 300 via the first outlet 302.

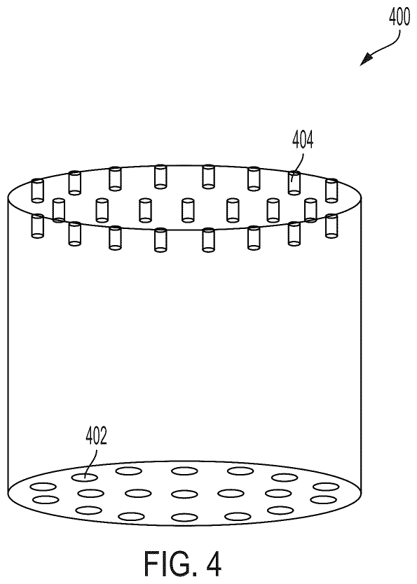

FIG. 4 is a plan view of an example DOC vessel 400 illustrating placement of gas diffusers 402 and float valves 404 therein. In various implementations, the DOC vessel 400 may be the DOC vessel 300 illustrated in FIG. 3, the DOC vessel 200 illustrated in FIG. 2, the DOC vessel 102 illustrated in FIG. 1, or another DOC vessel. FIG. 4 illustrates an example arrangement of gas diffusers 402 in a bottom region of the DOC vessel 400. In various implementations the gas diffusers 402 may be the gas diffusers 308 illustrated in FIG. 3, the gas diffusers 216 illustrated in FIG. 2 or another gas diffuser. In various implementations, the gas diffusers 402 are arranged across the bottom region of the DOC vessel 400 in such a way that the gas diffusers 402 are distributed across a transverse cross-sectional area of the DOC vessel 400. Such an arrangement of the gas diffusers 402 increases interaction of the carrier gas with the seawater by increasing the contact surface area between the seawater and the carrier gas.

As illustrated in FIG. 4 one or more float valves 404 may be disposed in a top region of the DOC vessel 400. In various implementations, the one or more float valves 404 interact, for example, with the one or more outlets of a liquid distributor such as, for example, the liquid distributor 210. The one or more float valves 404 facilitate passive regulation of an amount of seawater that is present in the interior of the DOC vessel 400 without active control system. That is, when a seawater level in the interior of the DOC vessel reaches an upper threshold, the one or more float valves 404 closes the one or more openings in the liquid distributor thereby limiting a supply of seawater to the DOC vessel. When the seawater level in the interior of the DOC vessel falls below a second threshold, the one or more float valves 404 open the one or more openings in the liquid distributor allowing seawater to flow into the interior of the DOC vessel.

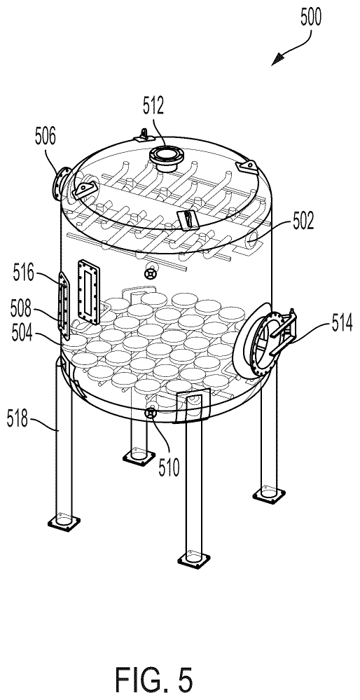

FIG. 5 is a perspective view of an example DOC vessel 500 illustrating external features thereof. In various implementations, the example DOC vessel 500 may be the example DOC vessel 400 illustrated in FIG. 4, the example DOC vessel 300 illustrated in FIG. 3, the example DOC vessel 200 illustrated in FIG. 2, the example DOC vessel 102 illustrated in FIG. 1, or another DOC vessel. In FIG. 5, a liquid distributor 502 is shown disposed in a top region of the example DOC vessel 500 and a gas diffuser 504 is shown disposed in a bottom region of the example DOC vessel 500. In various implementations, the liquid distributor 502 may be, for example, the liquid distributor 210 illustrated in FIG. 2 or another liquid distributor. The gas diffuser 504 may be, for example, the gas diffuser 216 illustrated in FIG. 2 or another gas diffuser. A first inlet 506 is disposed on an exterior of the example DOC vessel and is fluidly coupled to the liquid distributor 502 for supply of acidified seawater to the interior of the example DOC vessel 500. A second inlet 508 is disposed on an exterior of the example DOC vessel 500 and is fluidly coupled to the gas diffuser 504 for supply of carrier gas to the interior of the example DOC vessel 500. A water outlet 510 is formed in a bottom region of the example DOC vessel for removal of CO₂-lean seawater from the example DOC vessel 500. A gas port 512 is formed in a top region of the example DOC vessel 500 for removal of product gas from the interior of the DOC vessel 500. In various implementations, the product gas includes a mixture of the carrier gas and extracted CO₂.

In various implementations, one or more manways 514 may be formed in the exterior of the example DOC vessel 500. In various implementations, the one or more manways 514 provide access to the interior of the example DOC vessel 500 for maintenance or repair. Additionally, one or more sight glasses 516 may be formed in the exterior of the example DOC vessel 500. In various implementations, the one or more sight glasses 516 facilitate visibility into the interior of the example DOC vessel 500 during operation (e.g., to assess performance, the need for maintenance, etc.). In various implementations, legs 518 may be coupled to the bottom region of the example DOC vessel 500 to support the example DOC vessel 500 above floor level. In various implementations, the legs 518 facilitate access to a bottom region of the example DOC vessel 500 and facilitate plumbing to the bottom region of the example DOC vessel.

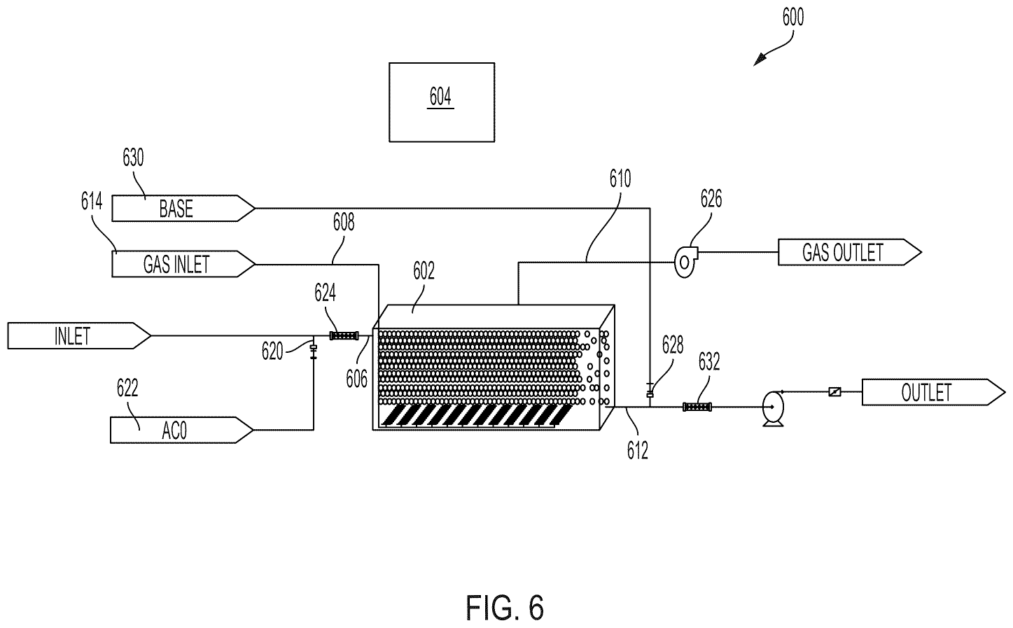

FIG. 6 is a schematic diagram of an example cross-flow DOC system 600. The example DOC system 600 illustrated in FIG. 6 includes one or more DOC vessels 602 and a control system 604. Each of the one or more DOC vessels 602 includes a first inlet 606 for CO₂-rich seawater and a second inlet 608 for receiving a carrier gas. Additionally, the one or more DOC vessels 602 includes a first outlet 610 for removal of a product gas from the DOC vessel 602 and a second outlet 612 for removal of CO₂-lean seawater from the DOC vessel 602. The example DOC system 600 may include additional or different features, and the components of the DOC system 600 may operate as described with respect to FIGS. 1A-1B or in another manner.

In some implementations, the DOC vessel 602 is configured to receive CO₂-rich seawater containing dissolved CO₂ gas. In some instances, seawater may be acidified before being received at the DOC vessel 602. For example, the pH of the seawater may be reduced from an initial value (e.g., 8.1 or another value) to a lower value before the seawater is received at first inlet 606 of the DOC vessel 602. For example, the pH value of the acidified seawater may be equal to or greater than 6, 5, 4, or another value. In certain instances, the seawater may be screened, filtered, heated, or processed in another manner prior to the acidification process. The acidified seawater may be introduced into the DOC vessel, where it comes into contact with the carrier gas that is introduced through the second inlet 608.

In some implementations, the acidification process includes mixing an acidic solution with the processed seawater. In some instances, the acidic solution includes hydrochloric acid (HCl), or other types of acid. In some instances, the acidic solution used to obtain the acidified seawater may be generated onsite as part of the example DOC system 600 using, for example, an electrodialysis process or obtained in another manner. In some implementations, the acidic solution introduced to the seawater during the acidification process can react with dissolved inorganic carbon in forms of bicarbonate and carbonate in the seawater; and can convert the dissolved inorganic carbon to aqueous CO₂ and increase the concentration of the dissolved aqueous CO₂ in the acidified seawater. In some instances, other processes or other treatment to the seawater to increase the concentration of the dissolved CO₂ gas may be used.

In some implementations, the carrier gas may be ambient air or another gas such as, for example, oxygen (O₂), hydrogen (H₂), nitrogen (N₂), helium (He), argon (Ar), carbon monoxide (CO). In various implementations, the carrier gas may be supplied from an external source such as, for example, a gas tank to the second inlet 608 of the DOC vessel 602. In other implementations, the carrier gas may be ambient air introduced to the second inlet 608 of the DOC vessel 602 via, for example, a check valve 614. In still other implementations, the carrier gas may be dissolved in the acidified seawater.

In some aspects of operation, the DOC vessel 602 operates by the application of Henry's Law, for example, as described above with respect to FIGS. 1A and 1B. For instance, as the partial pressure of a gas decreases, the molar concentration of the aqueous phase of the gas will also decrease.

In some implementations, the control system 604 is communicably coupled to one or more control units (e.g., water pumps, flow sensor, vacuum pumps, pressure sensor, etc.) to adjust the pH and the flow rate of the seawater into the DOC vessel 602, and the flow rate of the carrier gas or vacuum (e.g., partial pressure) applied to the DOC vessel 602. In some instances, the control system 604 may be coupled to other components of the DOC system 600 to control other parameters. For example, the control system 604 may be coupled to a gas chromatograph or CO₂ sensor configured to analyze and evaluate the CO₂ concentration collected from the DOC vessel 602, a pH sensor configured to measure the pH values of the seawater, and other components or devices of the example DOC system 600. In some implementations, the control system 604 includes one or more computer processors, a memory unit, an input/output interface, or other components that allow the communication of the control system 604 with other components of the example DOC system 600, determine control parameter values of the components of the example DOC system 600, and optimize the CO₂ removal performance of the example DOC system 600. In some instances, the control system 104 may be configured for performing other functions.

In various implementations, the example DOC system 600 is configured to introduce seawater to the interior of the DOC vessel 602 via the first inlet 606. In various implementations, the seawater is introduced via naturally occurring water movement such as, for example, currents or tides. In other implementations, a seawater intake system such as, for example, a water pump may be configured to supply the seawater to the DOC vessel 602. In various implementations, the seawater intake system may be, for example, a centrifugal pump, a reciprocal pump, a turbine pump, or another type of pump. In various implementations, the seawater intake system may receive the seawater from the surface of the body of water or water from any depth below the surface of the water. An acid pump 620 is configured to feed the acidic solution to the seawater during the acidification process. In various implementations, the acid pump 620 is coupled to an acid supply 622 and an acid mixer 624. In various implementations, the acid supply 622 may be, for example, an acid tank and the acid mixer 624 may be, for example, a static mixer that is configured to mix the acidic solution with the seawater. In such implementations, the acid mixer 624 is coupled to the first inlet 606. In some implementations, the acid mixer may not be needed.

In various implementations, a vacuum pump 616 is coupled to the first outlet 610 of the DOC vessel 602. The vacuum pump 616 may be, for example, a liquid ring vacuum pump; however, in other implementations, the vacuum pump 616 may be, for example, a rotary vane vacuum pump, a diaphragm vacuum pump, a scroll vacuum pump, a turbomolecular vacuum pump, or another type of vacuum pump.

In various implementations, the example DOC system 600 includes a discharge pump 626 that is configured to remove CO₂-lean seawater from the DOC vessel via the second outlet 612. In various implementations, the discharge pump 626 may be, for example, a centrifugal pump, a reciprocal pump, a turbine pump, or another type of pump. In various implementations, the discharge pump 626 may discharge the CO₂-lean seawater to the surface of the body of water or water from any depth below the surface of the water. An alkaline pump 628 is configured to feed an alkaline solution to the CO₂-lean seawater. In various implementations, the alkaline pump 628 is coupled to an alkaline supply 630 and an alkaline mixer 632. In various implementations, the alkaline supply 630 may be, for example, an alkaline tank and the alkaline mixer 632 may be, for example, a static mixer that is configured to mix the alkaline solution with the CO₂-lean seawater supplied from the DOC vessel 602. In such implementations, the alkaline mixer 632 is coupled to the discharge pump 626.

In some instances, multiple DOC vessels 602 in the example DOC system 600 may be connected in series. For example, the seawater can go through a series of DOC vessels 602 until a certain condition is met (e.g., for example a concentration of the dissolved CO₂ gas in the seawater is below a predetermined threshold limit). In some instances, the acidified seawater can be processed in parallel by simultaneously operating multiple DOC vessels 602 to improve production. In some instances, a subset of DOC vessels 602 may be connected in series, and multiple subsets of DOC vessels 602 may be connected in parallel. The multiple DOC vessels 602 may include different types of carrier gases. In some instances, the multiple DOC vessels 102 may operate under different conditions (e.g., different pH values, pressure, flow rate, flow direction, etc.). In some instances, output of the example DOC system 100 includes the acidified seawater with a reduced concentration of the dissolved CO₂ gas (CO₂-lean seawater). The acidified seawater from the second outlet 612 of the DOC vessel 602 may be neutralized by injecting an alkaline solution (e.g., sodium hydroxide NaOH) to increase its pH value during an alkalinization process prior to being returned back to the body of water. In some instances, the CO₂ gas collected from the DOC vessels 602 may be collected for later processing.

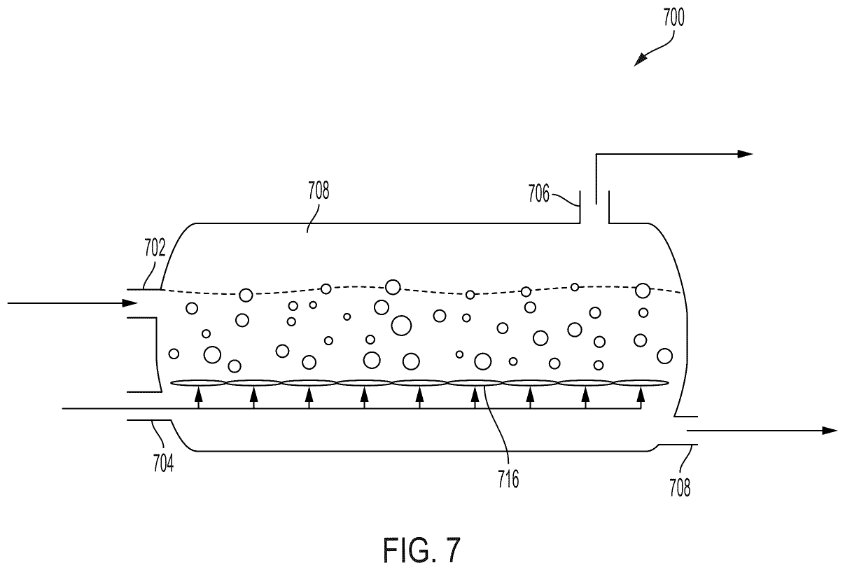

FIG. 7 is a plan view of an example cross-flow DOC vessel 700 illustrating interior features thereof. In various implementations the example cross-flow DOC vessel 700 may be the DOC vessel 602 or another vessel. The example DOC vessel includes a first inlet 702 for receiving CO₂-rich seawater and a second inlet 704 for receiving carrier gas. In various implementations the first inlet 702 may be the first inlet 606 or another inlet. The second inlet 704 may be the second inlet 608 or another inlet. The example DOC vessel 702 includes a first outlet 706 for removal of product gas from the DOC vessel 700 and a second outlet 708 for removal of CO₂-lean seawater from the example DOC vessel 700. In various implementations, the first outlet 706 may be the first outlet 610 or another outlet and the second outlet 708 may be the second outlet 612 or another outlet.

The first inlet 702 is configured to introduce CO₂-rich seawater to an interior of the example DOC vessel 700. In various implementations, the first inlet 702 is disposed in a top region of the DOC vessel 700 and injects the CO₂-rich seawater into the DOC vessel 700 such that the seawater flows across a transverse cross-sectional area of the DOC vessel 700. In other words, the seawater flows through the DOC vessel in a direction perpendicular to gravity. The CO₂-rich seawater introduced by the first inlet 702 is collected in a bottom region of the example DOC vessel 700.

The example DOC vessel 700 includes one or more gas diffusers 716 formed in the bottom region of the example DOC vessel 700 and coupled to the second inlet 704. In various implementations, the one or more gas diffusers 716 may be coupled to a gas manifold that is, in turn, coupled to the second inlet 704. In various implementations the one or more gas diffusers 716 are configured to facilitate the generation of bubbles of carrier gas within the accumulated CO₂-rich seawater. In various implementations, the one or more gas diffusers 716 may include, for example, porous diffusers (such as porous plate diffusers), porous membranes, injector nozzles, static mixers, or another type of diffuser. The one or more gas diffusers 716 introduce carrier gas to the accumulated CO₂-rich seawater. The carrier gas forms bubbles of various sizes in the seawater. The carrier gas bubbles rise through the seawater in a direction opposite the direction of gravity such that the direction of flow of the carrier gas bubbles is orthogonal to the flow of the seawater through the DOC vessel 700. Bubbling the carrier gas through the CO₂-rich seawater reduces the partial pressure of CO₂ in a head space 718 above the seawater and causes the CO₂ dissolved in the seawater to be extracted from the seawater. A product gas, which includes the extracted CO₂, the carrier gas, and other gases extracted from the seawater accumulates in the head space 718. The product gas is communicated from the example DOC vessel 700 by a first outlet 706. CO₂-lean seawater that remains in the bottom region of the example DOC vessel 700 is removed via the second outlet 708.

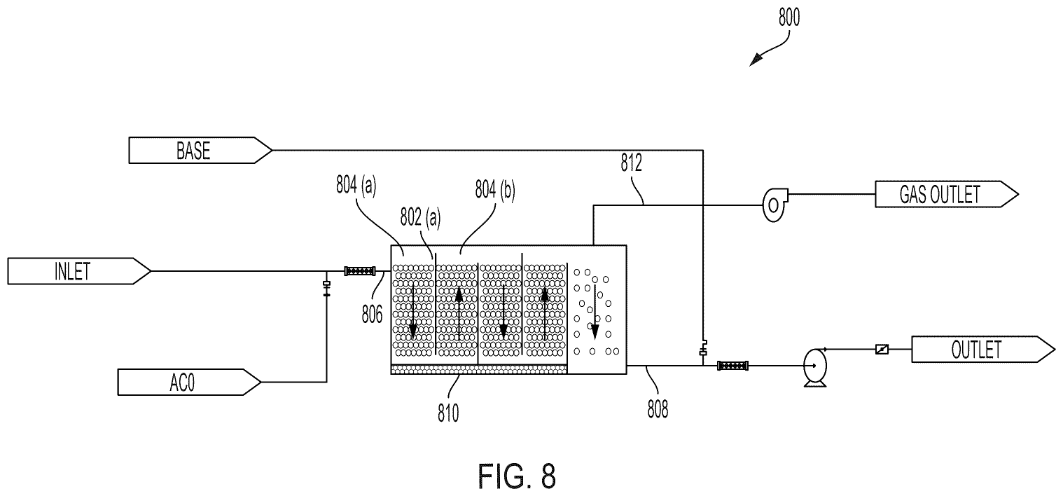

FIG. 8 is a plan view of an example cross-flow DOC vessel 800 illustrating compartmentalized flow therethrough. The DOC vessel 800 includes one or more baffles 802 that divide an interior of the DOC vessel into one or more chambers 804. In various implementations, the DOC vessel 800 may be the DOC vessel 700 or another vessel. CO₂-rich seawater enters a first chamber 804(a) inside the DOC vessel 800 via a first inlet 806. The seawater travels downwardly and around a first baffle 802(a) into a second chamber 804(b) where the seawater travels in an upward direction. The seawater continues this alternating pattern of flow until the seawater reaches a first outlet 808. Thus, a direction of flow of the seawater in adjacent chambers is opposite.

Meanwhile, the carrier gas is introduced to the DOC vessel 800 via a gas diffuser 810 located in a bottom region of the DOC vessel 800. The carrier gas forms bubbles in the seawater in each of the chambers 804. The carrier gas extracts dissolved CO₂ from the seawater. Product gas that includes the extracted CO₂ collects in a top region of the DOC vessel 800 and is communicated from the example DOC vessel 800 via a second outlet 812.

FIG. 9A is a block diagram of an example DOC system 900 in a first mode of operation. In various implementations, the example DOC system 900 may be, for example, the DOC system 100 illustrated in FIG. 1, the DOC system 600 illustrated in FIG. 6 or another DOC system. The first mode of operation shown in FIG. 9A may be referred to as “vacuum mode”. The example DOC system 900 includes one or more DOC vessels 902. The DOC vessel 902 may be the DOC vessel 102 illustrated in FIG. 1, the DOC vessel 602 illustrated in FIG. 6 or another DOC vessel. The DOC vessel 902 has a first inlet 904 for receiving CO₂-rich seawater. The CO₂-rich seawater may be supplied, for example, by an ocean 906, a sea, or another body of water. The DOC system 900 includes an acidifying agent supply 908. In various implementations, the acidifying agent may be hydrochloric acid (HCl) or another acidifying agent. The acidifying agent mixes with the CO₂-rich seawater in an acid mixer 910. Interaction of the acidifying agent and the seawater reduces a pH of the CO₂-rich seawater before the CO₂-rich seawater is introduced into the DOC vessel 902.

A vacuum pump 912 is coupled to the DOC vessel 902. In various implementations, the vacuum pump 912 may be, for example, a liquid ring vacuum pump or another type of vacuum pump. During operation, the vacuum pump 912 reduces an internal pressure within the DOC vessel. In various implementations, the vacuum pump 912 reduces the pressure inside the DOC vessel to a value in the range of approximately 10 millibar (mbar) to approximately 100 millibar (mbar). In the first mode of operation, a head space volume can be maximized inside the DOC vessel 902 in order to enhance gas removal efficiency. Reduction of the pressure within the DOC vessel 902 causes gases dissolved in the acidified CO₂-rich seawater to come out of solution by operation of Henry's law. Thus, CO₂-lean gases such as, oxygen (O₂), hydrogen (H₂), nitrogen (N₂), helium (He), argon (Ar), carbon monoxide (CO), ambient air, or water vapor begin to come out of solution and form bubbles within the seawater. These gas bubbles function as the carrier gas for extraction of CO₂ when the example DOC system 900 is operating in vacuum mode. In the example shown in FIG. 9A, when operating in vacuum mode, no external carrier gas is supplied to the DOC vessel 902. Thus, the DOC vessel 902 does not utilize a gas diffuser in the example shown.

The reduction of the partial pressure of CO₂ due to the use of vacuum and/or carrier gas sweep induces the extraction of CO₂ from the acidified seawater by operation of Henry's Law. Extraction of CO₂ leaves an acidified CO₂-lean seawater in the DOC vessel 902. A product gas 913, which includes a mixture of extracted CO₂ and carrier gases accumulates in the head space and is removed from the DOC vessel 902 by operation of the vacuum pump 912. In various implementations, vacuum mode is capable of achieving a CO₂ removal efficiency in the range of approximately 80% to approximately 90%. That is, vacuum mode may be capable of removing approximately 80% to approximately 90% of CO₂ that is dissolved in a volume of CO₂-rich seawater. In some examples, vacuum mode generates CO₂ with a purity in the range of approximately 65% to approximately 70%. That is, the product gas 913 generated by the DOC system 900 may be approximately 65% to approximately 70% CO₂. In some cases, operating in vacuum mode may achieve a different level of removal efficiency, CO₂ purity and other parameters.

In various implementations, the acidified CO₂-lean seawater is removed from the DOC vessel 902 via a first outlet 914. The acidified CO₂-lean seawater flows into an alkaline mixer 916 where an alkaline agent is added from an alkaline source 918. In various implementations the alkaline agent may be, for example, sodium hydroxide (NaOH) or another alkaline agent. The alkaline mixer 916 may be, for example, a static mixer or another type of mixer. Interaction of the acidified CO₂-lean seawater with the alkaline agent raises a pH of the seawater and creates a product CO₂-lean seawater. In various implementations, the product CO₂-lean seawater has a pH of, for example, 8.1; however, the pH of the product CO₂-lean seawater may be varied depending on environmental conditions. In the example shown, the product CO₂-lean seawater is then returned to the ocean 906. In various implementations, a discharge pump may be utilized to facilitate removal of the acidified CO₂-lean seawater from the DOC vessel 902. In various implementations, the discharge pumps have a low net positive suction head (NPSH) so as to maintain a sufficient water level in the DOC vessel 902. Such management of the water level in the DOC vessel 902 facilitates sufficient suction head for the discharge pumps, prevents cavitation, and facilitates efficient water removal. In some implementations, a gravity drain may be utilized as an alternative to the discharge pump. By configuring the height or altitude of the DOC vessel relative to the body of water, the system can counteract the negative pressure generated by the applied vacuum.

FIG. 9B is a block diagram of an example multi-stage example DOC system 950 in the first mode of operation. The example DOC system 950 includes a first DOC vessel 951 and a second DOC vessel 952. The first DOC vessel 951 and the second DOC vessel 952 may be the DOC vessel 102 illustrated in FIG. 1, the DOC vessel 602 illustrated in FIG. 6 or another DOC vessel. The first DOC vessel 951 has a first inlet 954 for receiving dissolved inorganic carbon (DIC)-rich seawater. The DIC-rich seawater may be supplied, for example, by an ocean 956, a sea, or another body of water. A first vacuum pump 957 is in fluid communication with the first DOC vessel 951. In various implementations, the first vacuum pump 957 may be, for example, a liquid ring vacuum pump or another type of vacuum pump. During operation, the first vacuum pump 957 reduces an internal pressure within the first DOC vessel 951. In various implementations, the first vacuum pump 957 reduces the pressure inside the first DOC vessel 951 to a value in the range of approximately 100-300 millibar (mbar). Reduction of the pressure within the first DOC vessel 951 causes ambient air dissolved in the DIC-rich seawater to come out of solution by operation of Henry's law. Thus, the ambient air 959 begins to come out of solution and form bubbles within the seawater. The extracted air is communicated away from the first DOC vessel 951 by the first vacuum pump 957 leaving de-gassed seawater in the first DOC vessel 951. The de-gassed seawater is passed to an acid mixer 960.

The DOC system 950 includes an acidifying agent supply 958. In various implementations, the acidifying agent may be hydrochloric acid (HCl) or another acidifying agent. The acidifying agent mixes with the de-gassed seawater in the acid mixer 960. Interaction of the acidifying agent and the de-gassed seawater reduces a pH of the de-gassed seawater before the de-gassed seawater is introduced into the second DOC vessel 952.

A second vacuum pump 962 is coupled to the second DOC vessel 952. In various implementations, the second vacuum pump 962 may be, for example, a liquid ring vacuum pump or another type of vacuum pump. During operation, the second vacuum pump 962 reduces an internal pressure within the second DOC vessel 952. In various implementations, the second vacuum pump 962 reduces the pressure inside the second DOC vessel 952 to a value in the range of approximately 10 millibar (mbar) to approximately 100 millibar (mbar). In the first mode of operation, a head space volume is maximized inside the second DOC vessel 952 in order to enhance gas removal efficiency. Reduction of the pressure within the second DOC vessel 952 causes gases dissolved in the acidified de-gassed seawater to come out of solution by operation of Henry's law. In various implementations, a majority of the dissolved gas in the second DOC vessel 952 is dissolved CO₂, where other dissolved gases, such as oxygen (O₂), hydrogen (H₂), nitrogen (N₂) were removed in the first DOC vessel 951. This results in a higher purity of CO₂ in the product gas. When operating in vacuum mode, no external carrier gas is supplied to the DOC vessel 952. Thus, in the example shown, the DOC vessel 952 does not utilize a gas diffuser.

The reduction of the partial pressure of CO₂ due to the use of vacuum and/or carrier gas sweep induces the extraction of CO₂ from the acidified seawater by operation of Henry's Law. Extraction of CO₂ leaves an acidified CO₂-lean seawater in the second DOC vessel 952. A product gas 963, which includes a mixture of extracted CO₂ and carrier gases accumulates in the head space and is removed from the second DOC vessel 952 by operation of the second vacuum pump 912. In various implementations, the example multi-stage DOC system 950 achieves a high CO₂ purity than a single stage DOC system when operating in vacuum mode.

In various implementations, the acidified CO₂-lean seawater is removed from the second DOC vessel 952 via a first outlet 964. The acidified CO₂-lean seawater flows into an alkaline mixer 966 where an alkaline agent is added from an alkaline source 968. In various implementations the alkaline agent may be, for example, sodium hydroxide (NaOH) or another alkaline agent. The alkaline mixer 966 may be, for example, a static mixer or another type of mixer. Interaction of the acidified CO₂-lean seawater with the alkaline agent raises a pH of the seawater and creates a product CO₂-lean seawater. In various implementations, the product CO₂-lean seawater has a pH of, for example, 8.1; however, the pH of the product CO₂-lean seawater may be varied depending on environmental conditions. The product CO₂-lean seawater is then returned to the ocean 956. In various implementations, a discharge pump may be utilized to facilitate removal of the acidified CO₂-lean seawater from the DOC vessel 902. In various implementations, the discharge pumps have a low net positive suction head (NPSH) so as to maintain a sufficient water level in the second DOC vessel 952. Such management of the water level in the second DOC vessel 952 facilitates sufficient suction head for the discharge pumps, prevents cavitation, and facilitates efficient water removal. In some implementations, a gravity drain may be utilized as an alternative to the discharge pump. By configuring the height or altitude of the DOC vessel relative to the body of water, the system can counteract the negative pressure generated by the applied vacuum.

FIG. 10A is a block diagram of an example DOC system 1000 in a second mode of operation. In various implementations, the example DOC system 1000 may be, for example, the DOC system 100 illustrated in FIG. 1, the DOC system 600 illustrated in FIG. 6 or another DOC system. The second mode of operation may be referred to as “combo mode”. The example DOC system 1000 includes one or more DOC vessels 1002. The DOC vessel 1002 may be the DOC vessel 102 illustrated in FIG. 1, the DOC vessel 602 illustrated in FIG. 6 or another DOC vessel. The DOC vessel 1002 has a first inlet 1004 for receiving CO₂-rich seawater. The CO₂-rich seawater may be supplied, for example, from an ocean 1006, a sea, or another body of water. The DOC system 1000 includes an acidifying agent supply 1008. In various implementations, the acidifying agent may be hydrochloric acid (HCl) or another acidifying agent. The acidifying agent mixes with the CO₂-rich seawater in an acid mixer 1010. Interaction of the acidifying agent and the seawater reduces a pH of the CO₂-rich seawater before the CO₂-rich seawater is introduced into the DOC vessel 1002.

In the example shown in FIG. 10A, a vacuum pump 1012 is coupled to the DOC vessel 1002. In various implementations, the vacuum pump 1012 may be, for example, a liquid ring vacuum pump or another type of vacuum pump. During operation, the vacuum pump 1012 reduces an internal pressure within the DOC vessel. In various implementations, the vacuum pump 1012 reduces the pressure inside the DOC vessel to a value in the range of approximately 100 mbar to approximately 350 mbar. In the example shown, reduction of pressure within the DOC vessel 1002 causes ambient air 1014 to be pulled into the DOC vessel 1002 from outside the DOC vessel 1002. Flow of the ambient air 1014 into the DOC vessel 1002 is regulated by a gas flow controller 1016. In various implementations, the gas flow controller 1016 may be, for example, a check valve, or another type of valve or other flow controller. The introduced ambient air 1014 flows through a gas diffuser that resides in a bottom region of the DOC vessel and forms bubbles in the acidified CO₂-rich seawater. In various implementations, the DOC vessel 1002 may be designed with a counter-flow arrangement as described in FIGS. 1-5 or with a cross-flow arrangement as described in FIGS. 6-8. The ambient air bubbles function as the carrier gas for extraction of CO₂ when the example DOC system 1000 is operating in combo mode.

The reduction of the partial pressure of CO₂ due to the use of vacuum and/or carrier gas sweep induces the extraction of CO₂ from the acidified seawater by operation of Henry's Law. Extraction of CO₂ leaves an acidified CO₂-lean seawater in the DOC vessel 1002. A product gas 1013, which includes a mixture of extracted CO₂ and ambient air, accumulates in the head space and is removed from the DOC vessel 1002 by operation of the vacuum pump 1012. In various implementations, combo mode is capable of achieving a CO₂ removal efficiency in the range of approximately 85% to approximately 95%. That is, combo mode may be capable of removing approximately 85% to approximately 95% of CO₂ that is dissolved in a volume of CO₂-rich seawater. In some cases, combo mode generates CO₂ with a purity in the range of approximately 15% to approximately 22%. That is, the product gas 1013 generated by the DOC system 1000 can be approximately 15% to approximately 22% CO₂. In some cases, operating in combo mode may achieve a different level of removal efficiency, CO₂ purity and other parameters.

In various implementations, the acidified CO₂-lean seawater is removed from the DOC vessel 1002 via an outlet. The acidified CO₂-lean seawater flows into an alkaline mixer 1020 where an alkaline agent is added from an alkaline source 1018. In various implementations the alkaline agent may be, for example, sodium hydroxide (NaOH) or another alkaline agent. The alkaline mixer 1020 may be, for example, a static mixer or another type of mixer. Interaction of the acidified CO₂-lean seawater with the alkaline agent raises a pH of the seawater and creates a product CO₂-lean seawater. In various implementations, the product CO₂-lean seawater has a pH of 8 or greater; however, the pH of the product CO₂-lean seawater may be varied depending on environmental conditions. The product CO₂-lean seawater is then returned to the ocean 1006.

FIG. 10B is a block diagram of an example DOC system 1050 in a third mode of operation. In various implementations, the example DOC system 1050 may be, for example, the DOC system 100 illustrated in FIG. 1, the DOC system 600 illustrated in FIG. 6 or another DOC system. The second mode of operation may be referred to as “air sparging mode”. The example DOC system 1050 includes one or more DOC vessels 1052. The DOC vessel 1052 may be the DOC vessel 102 illustrated in FIG. 1, the DOC vessel 602 illustrated in FIG. 6 or another DOC vessel. In the example shown, the DOC vessel 1052 has a first inlet 1054 for receiving CO₂-rich seawater. The CO₂-rich seawater may be supplied, for example, from an ocean 1056, a sea, or another body of water. The DOC system 1050 includes an acidifying agent supply 1058. In various implementations, the acidifying agent may be hydrochloric acid (HCl) or another acidifying agent. The acidifying agent mixes with the CO₂-rich seawater in an acid mixer 1060. Interaction of the acidifying agent and the seawater reduces a pH of the CO₂-rich seawater before the CO₂-rich seawater is introduced into the DOC vessel 1052.

As shown in FIG. 10B, a flow of carrier gas 1064 into the DOC vessel 1052 is regulated by a gas pump 1066. In various implementations, the gas pump 1066 may be, for example, a blower, a fan, or another type of gas pump. The introduced carrier gas 1064 flows through a gas diffuser disposed in a bottom region of the DOC vessel 1052 and forms bubbles in the acidified CO₂-rich seawater. In various implementations, the DOC vessel 1052 may be designed with a counter-flow arrangement as described in FIGS. 1-5 or with a cross-flow arrangement as described in FIGS. 6-8. The carrier gas facilitates extraction of CO₂ when the example DOC system 1050 is operating in air sparging mode.

In the example shown, the reduction of the partial pressure of CO₂ due to the use of carrier gas sweep induces the extraction of CO₂ from the acidified seawater by operation of Henry's Law. Extraction of CO₂ leaves an acidified CO₂-lean seawater in the DOC vessel 1052. A product gas 1053, which includes a mixture of extracted CO₂ and carrier gas accumulates in the head space and is removed from the DOC vessel 1052 by operation of the gas pump 1066. In various implementations, air sparging mode is capable of achieving a CO₂ removal efficiency in the range of approximately 80% to approximately 85%. That is, air sparging mode may be capable of removing approximately 80% to approximately 85% of CO₂ that is dissolved in a volume of CO₂-rich seawater. In some cases, the air sparging mode generates CO₂ with a purity in the range of approximately 4% to approximately 6%. That is, the product gas 1053 generated by the DOC system 1050 may be approximately 4% to approximately 6% CO₂. In some cases, operating in air sparging mode may achieve a different level of removal efficiency, CO₂ purity and other parameters.

In various implementations, the acidified CO₂-lean seawater is removed from the DOC vessel 1052 via an outlet. The acidified CO₂-lean seawater flows into an alkaline mixer 1070 where an alkaline agent is added from an alkaline source 1068. In various implementations the alkaline agent may be, for example, sodium hydroxide (NaOH) or another alkaline agent. The alkaline mixer 1070 may be, for example, a static mixer or another type of mixer. Interaction of the acidified CO₂-lean seawater with the alkaline agent raises a pH of the seawater and creates a product CO₂-lean seawater. In various implementations, the product CO₂-lean seawater has a pH of, for example, 8.1; however, the pH of the product CO₂-lean seawater may be varied depending on environmental conditions. The product CO₂-lean seawater is then returned to the ocean 1056.

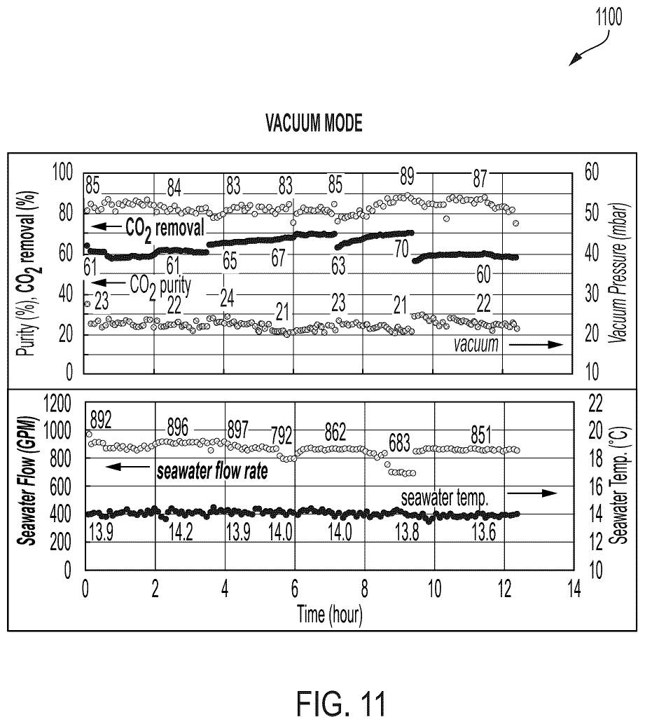

FIG. 11 is a graph 1100 illustrating CO₂ examples of removal efficiency and CO₂ purity according to the first mode of operation. FIG. 11 illustrates that, in an example where the system operates at vacuum pressures between approximately 20 and 25 mbar, the first mode of operation (vacuum mode) extracts CO₂ from seawater with approximately 85% to approximately 90% efficiency. The product gas generated by the first mode of operation is approximately 60% to approximately 70% CO₂. FIG. 11 further illustrates a seawater flow rate of approximately 680 gallons per minute (GPM) to approximately 900 GPM and a seawater temperature of approximately 14° C.

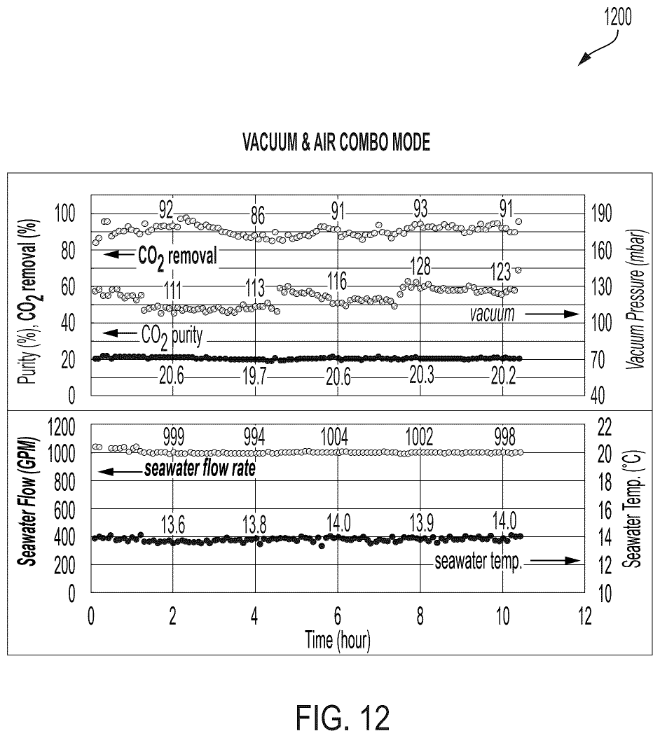

FIG. 12 is a graph 1200 illustrating CO₂ examples of removal efficiency and CO₂ purity according to the second mode of operation. FIG. 12 illustrates that, in an example where the system operates at vacuum pressures between approximately 110 mbar and approximately 130 mbar, the second mode of operation (combo mode) extracts CO₂ from seawater with approximately 80% to approximately 95% efficiency. The product gas generated by the second mode of operation is approximately 20% CO₂. FIG. 12 further illustrates a seawater flow rate of approximately 1000 gallons per minute (GPM) and a seawater temperature of approximately 14° C.

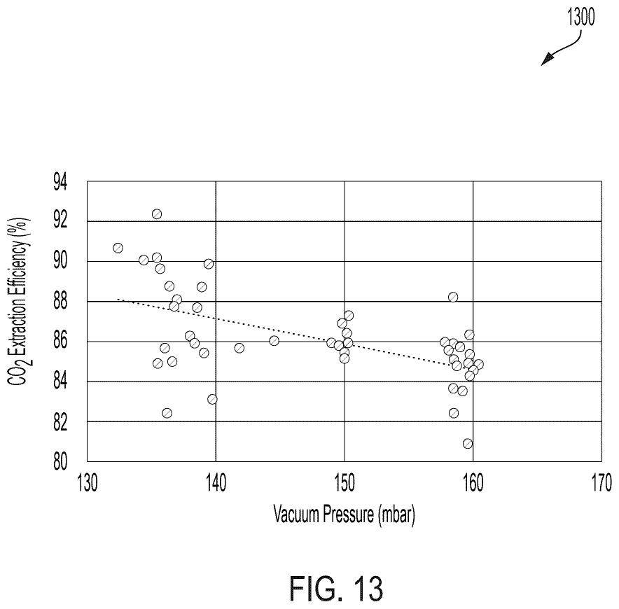

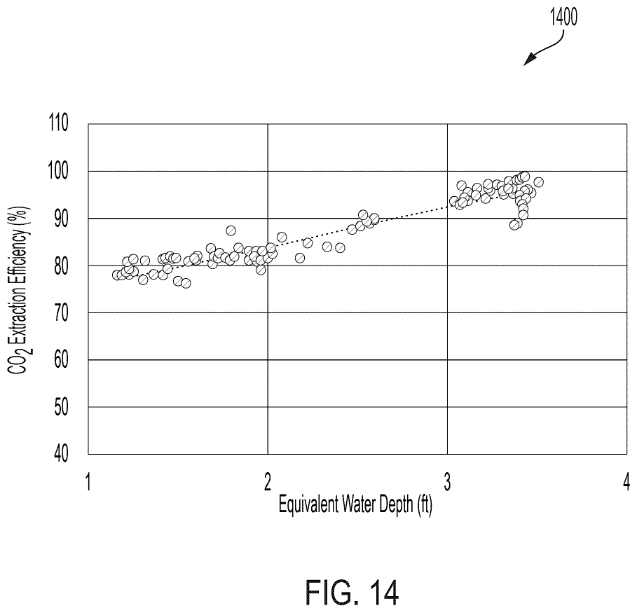

FIG. 13 is a graph 1300 illustrating examples of CO₂ extraction efficiency as a function of vacuum pressure. As illustrated in FIG. 13, extraction efficiency generally decreases with increasing vacuum pressure in combo mode. FIG. 14 is a graph illustrating examples of CO₂ extraction efficiency as a function of water depth. As illustrated in FIG. 14, CO₂ extraction efficiency generally increases with water depth in combo mode.

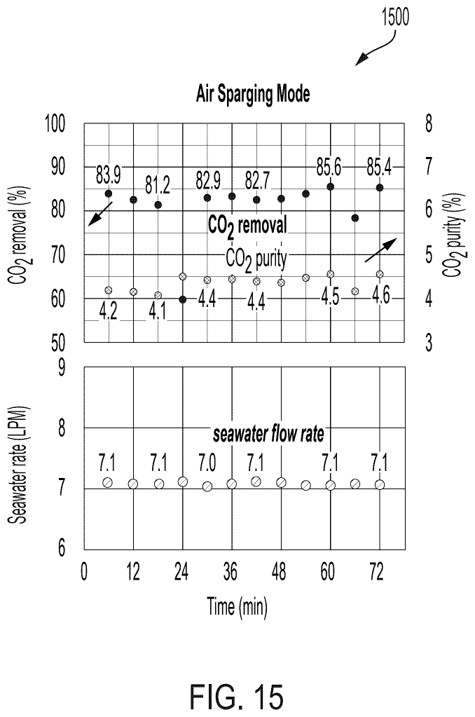

FIG. 15 is a graph illustrating examples of CO₂ removal efficiency and CO₂ purity according to a third mode of operation. FIG. 15 illustrates that, in an examples where the system operates without an applied vacuum pressure, the third mode of operation (air sparging mode) extracts CO₂ from seawater with approximately 80% to approximately 85% efficiency. The product gas generated by the second mode of operation is approximately 4% to approximately 6% CO₂. FIG. 12 further illustrates a seawater flow rate of approximately 7 liters per minute (LPM).

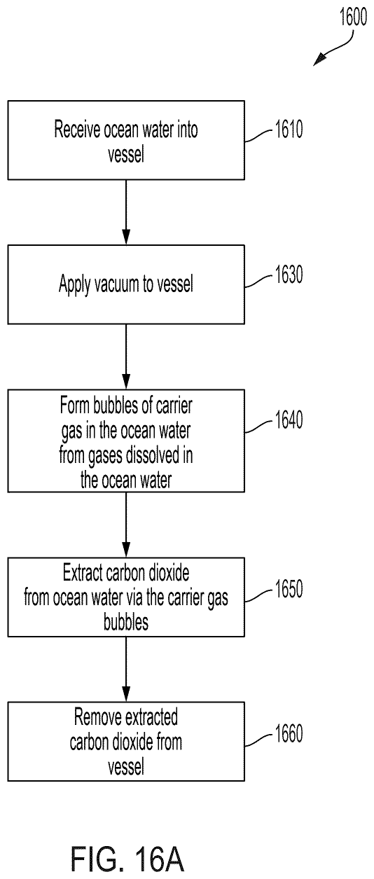

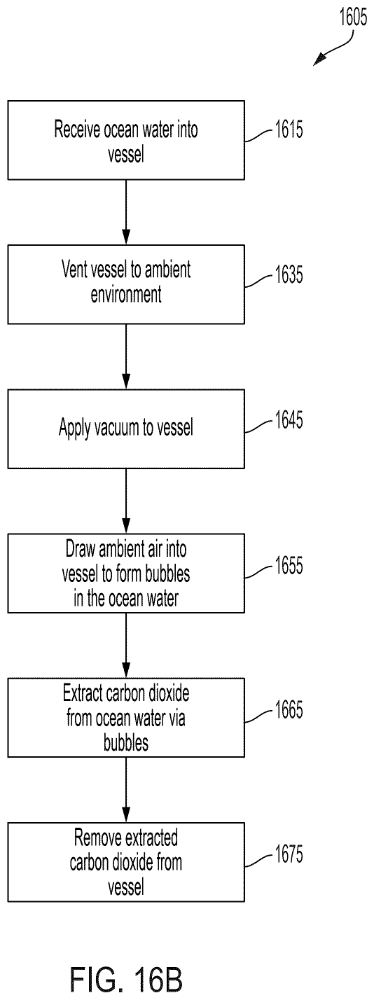

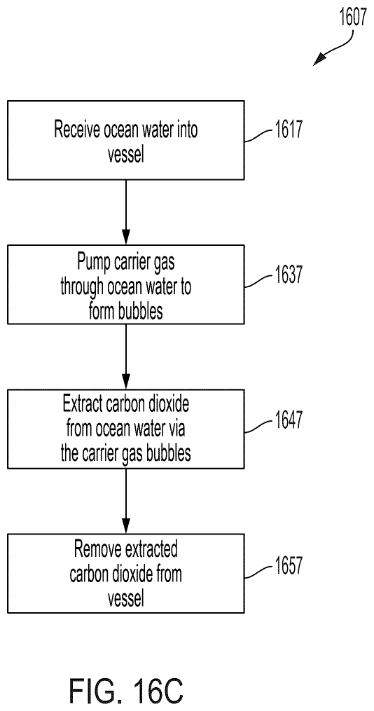

FIG. 16A is a flow diagram illustrating an example process 1600 for removal of CO₂ from seawater according to the first mode of operation (vacuum mode). A DOC system may be, for example, the counter-flow DOC system 100 illustrated in FIG. 1, the cross-flow DOC system 600 illustrated in FIG. 6 or another DOC system. The DOC system can remove dissolved CO₂ from seawater without the need for vessel packing. The example process 1600 may include additional or different operations, and the operations may be performed in the order shown or in another order. In some cases, one or more of the operations shown in FIG. 16A can be implemented as a process that includes multiple operations, sub-processes, or other types of routines. In some cases, operations can be combined, performed in another order, performed in parallel, iterated or otherwise repeated, or performed in another manner.

At 1610, CO₂-rich seawater is received into a DOC vessel. In various implementations, the DOC vessel may be a counter-flow DOC vessel such as the DOC vessel 102 illustrated in FIG. 1 or a cross-flow DOC vessel such as the DOC vessel 602 illustrated in FIG. 6. In various implementations, the CO₂-rich seawater undergoes an acidification process before being introduced to the DOC vessel. In such implementations, an acidifying agent may be added to the CO₂-rich seawater in an acid mixer such as, for example, a static mixer.

At 1630, when operating in vacuum mode, a vacuum pump reduces a pressure in an interior of the DOC vessel. In various implementations, the pressure generated by the vacuum pump may be in the range of approximately 20 mbar to approximately 40 mbar. At 1640, reduction in pressure inside the DOC vessel causes gases dissolved in the acidified CO₂-rich seawater to come out of solution (e.g., by operation of Henry's law as discussed above). Thus, CO₂-lean gases such as, oxygen (O₂), hydrogen (H₂), nitrogen (N₂), helium (He), argon (Ar), carbon monoxide (CO), ambient air, or water vapor begin to come out of solution and form bubbles within the seawater. These gas bubbles function as the carrier gas for extraction of CO₂ when the example DOC system 900 is operating in vacuum mode. When operating in vacuum mode, there is no need to introduce a flow external carrier gas to the DOC vessel, and therefore the DOC vessel may operate without utilizing a gas diffuser.

At 1650, the reduction of the partial pressure of CO₂ due to the use of vacuum induces the extraction of CO₂ from the acidified seawater by operation of Henry's Law. Extraction of CO₂ leaves an acidified CO₂-lean seawater in the DOC vessel. A product gas, which includes a mixture of extracted CO₂ and carrier gases accumulates in the head space. In various implementation, vacuum mode is capable of achieving a CO₂ removal efficiency in the range of approximately 80% to approximately 90%. That is, vacuum mode may be capable of removing approximately 80% to approximately 90% of CO₂ that is dissolved in a volume of CO₂-rich seawater. In some cases, vacuum mode generates CO₂ with a purity of approximately 65% to approximately 70%. That is, the product gas generated by the DOC system may be approximately 65% to approximately 70% CO₂. At 1660, the product gas is extracted from the DOC vessel by a vacuum pump. A vacuum mode may operate in other parameter ranges in some cases, for example, providing other ranges of CO₂ removal efficiency or CO₂ purity.

FIG. 16B is a flow diagram illustrating an example process 1605 for removal of CO₂ from seawater according to the second mode of operation (combo mode). A DOC system may be, for example, the counter-flow DOC system 100 illustrated in FIG. 1, the cross-flow DOC system 600 illustrated in FIG. 6 or another DOC system. The DOC system can remove dissolved CO₂ from seawater without the need for vessel packing. The example process 1605 may include additional or different operations, and the operations may be performed in the order shown or in another order. In some cases, one or more of the operations shown in FIG. 16B can be implemented as a process that includes multiple operations, sub-processes, or other types of routines. In some cases, operations can be combined, performed in another order, performed in parallel, iterated or otherwise repeated, or performed in another manner.

At 1615, CO₂-rich seawater is received into a DOC vessel. In various implementations, the DOC vessel may be a counter-flow DOC vessel such as the DOC vessel 102 illustrated in FIG. 1 or a cross-flow DOC vessel such as the DOC vessel 602 illustrated in FIG. 6. In various implementations, the CO₂-rich seawater undergoes an acidification process before being introduced to the DOC vessel. In such implementations, an acidifying agent may be added to the CO₂-rich seawater in an acid mixer such as, for example, a static mixer.

At 1635, the DOC vessel is vented to receive ambient air from outside the DOC vessel. At 1645, a vacuum pump reduces an internal pressure within the DOC vessel. In various implementations, the vacuum pump reduces the pressure inside the DOC vessel to a range of approximately 100 mbar to approximately 350 mbar. At 1655, reduction of pressure within the DOC vessel causes ambient air to be pulled into the DOC vessel from outside the DOC vessel. Flow of the ambient air into the DOC vessel may regulated by a gas flow controller. In various implementations, the gas flow controller may be or include, for example, a check valve, or another type of flow controller. The introduced ambient air flows through a gas diffuser disposed in a bottom region of the DOC vessel and forms bubbles in the acidified CO₂-rich seawater. The ambient air bubbles function as the carrier gas for extraction of CO₂ when the example DOC system 1000 is operating in combo mode.

At 1665, the reduction of the partial pressure of CO₂ due to the use of vacuum and/or carrier gas sweep induces the extraction of CO₂ from the acidified seawater by operation of Henry's Law. Extraction of CO₂ leaves an acidified CO₂-lean seawater in the DOC vessel. At 1675, the product gas, which includes a mixture of extracted CO₂ and ambient air accumulates in the head space and is removed from the DOC vessel by operation of the vacuum pump. In various implementations, combo mode is capable of achieving a CO₂ removal efficiency in the range of approximately 85% to approximately 95%. That is combo mode is capable of removing approximately 85% to approximately 95% of CO₂ that is dissolved in a volume of CO₂-rich seawater. In some cases, combo mode generates CO₂ with a purity in the range of approximately 15% to approximately 22%. That is, the product gas generated by the DOC system may be approximately 15% to approximately 22% CO₂. Combo mode may operate in other parameter ranges in some cases, for example, providing other ranges of CO₂ removal efficiency or CO₂ purity.

FIG. 16C is a flow diagram illustrating an example process 1607 for removal of CO₂ from seawater according to the third mode of operation (air sparging mode). A DOC system may be, for example, the counter-flow DOC system 100 illustrated in FIG. 1, the cross-flow DOC system 600 illustrated in FIG. 6 or another DOC system. The DOC system can remove dissolved CO₂ from seawater without the need for vessel packing. The example process 1607 may include additional or different operations, and the operations may be performed in the order shown or in another order. In some cases, one or more of the operations shown in FIG. 16C can be implemented as a process that includes multiple operations, sub-processes, or other types of routines. In some cases, operations can be combined, performed in another order, performed in parallel, iterated or otherwise repeated, or performed in another manner.

At 1617, CO₂-rich seawater is received into a DOC vessel. In various implementations, the DOC vessel may be a counter-flow DOC vessel such as the DOC vessel 102 illustrated in FIG. 1 or a cross-flow DOC vessel such as the DOC vessel 602 illustrated in FIG. 6. In various implementations, the CO₂-rich seawater undergoes an acidification process before being introduced to the DOC vessel. In such implementations, an acidifying agent such as, for example hydrochloric acid (HCl) or another agent. In such implementations, the acidifying agent may be added to the CO₂-rich seawater in an acid mixer such as, for example, a static mixer.

At 1637, a carrier gas is pumped into the DOC vessel by operation of a blower. In various implementations, the carrier gas may be, for example, ambient air, hydrogen (H₂), oxygen (O₂), nitrogen (N₂), helium (He), Argon (Ar), carbon monoxide (CO), or another gas or mixtures thereof. The carrier gas may be introduced into the DOC vessel via a gas diffuser and form bubbles in the seawater.

At 1647, the reduction of the partial pressure of CO₂ due to the use of carrier gas sweep induces the extraction of CO₂ from the acidified seawater by operation of Henry's Law. Extraction of CO₂ leaves an acidified CO₂-lean seawater in the DOC vessel. At 1657, the product gas, which includes a mixture of extracted CO₂ and carrier gas accumulates in the head space and is removed from the DOC vessel by operation of the vacuum pump. In various implementations, air sparging mode is capable of achieving a CO₂ removal efficiency in the range of approximately 80% to approximately 85%. That is, air sparging mode may be capable of removing approximately 80% to approximately 85% of CO₂ that is dissolved in a volume of CO₂-rich seawater. In some cases, air sparging mode generates CO₂ with a purity in the range of approximately 4% to approximately 6%. That is, the product gas generated by the DOC system may be approximately 4% to approximately 6% CO₂. An air sparging mode may operate in other parameter ranges in some cases, for example, providing other ranges of CO₂ removal efficiency or CO₂ purity.

In a general aspect of what is described, carbon dioxide is removed from seawater.

In a first example, a method for extraction of direct ocean capture (DOC) of CO₂ (CO₂) from seawater includes receiving, in an interior volume of a vessel, acidified seawater that includes dissolved CO₂. A carrier gas is bubbled through the acidified seawater in the interior volume of the vessel, thereby causing the carrier gas to extract at least 80% of the CO₂ from the acidified seawater. a product gas that includes the extracted CO₂ is communicated from the interior of the vessel. The product gas includes at least 4% CO₂.

In various implementations, aspects of the first example include collecting the acidified seawater in a bottom region of the interior volume of the vessel. The carrier gas is bubbled through the acidified seawater in the bottom region. The product gas is collected in a top region in the interior volume of the vessel. The product gas includes the extracted CO₂ and carrier gas that has bubbled through the acidified seawater. In various implementations, bubbling the carrier gas through the acidified seawater creates foam in a foam region between the bottom region and the top region in the interior volume of the vessel. In various implementations, bubbling the carrier gas through the acidified seawater creates microbubbles in the acidified seawater in a microbubble region between the bottom region and the foam region in the interior volume of the vessel.

In various implementations of the first example, bubbling the carrier gas through the acidified seawater includes communicating the carrier gas into the bottom region through a gas diffuser disposed in the bottom region. In various implementations, the carrier gas may be communicated through multiple gas diffusers disposed in the bottom region.

In various implementations of the first example, receiving the acidified seawater may include communicating the acidified seawater through a plurality of ports in a conduit system in the top region and introducing the acidified seawater from the top region to the bottom region.

In various implementations, aspects of the first example may include receiving the input seawater from a seawater intake system. An acid fluid is received from an acid tank. Acidified seawater is formed by mixing the acidic fluid with the input seawater. In various implementations, the acidified seawater has a pH of 6 or less.

In various implementations, aspects of the first example may include receiving CO₂-lean seawater from the interior volume of the vessel. An alkaline fluid is received from an alkaline tank. Product seawater is formed by mixing the alkaline fluid with the CO₂-lean seawater.

In various implementations of the first example, the carrier gas is communicated from an exterior of the vessel into the bottom region by operation of a blower.

In various implementations of the first example, the carrier gas is communicated from an exterior of the vessel into the bottom region due to pressure created in the interior volume by operation of a vacuum pump. In various implementations, the vacuum pump operates at 100-350 mbar.

In various implementations of the first example, the product gas is communicated from the top region to an exterior of the vessel by operation of the vacuum pump. In various implementations the product gas includes at least 15% CO₂.

In various implementations of the first example, the carrier gas is formed from dissolved gas in the acidified seawater in the interior volume due to pressure created in the interior volume by operation of a vacuum pump. In various implementations, the product gas includes at least 65% CO₂. In various implementations, the vacuum pump operates at a pressure of 10-100 mbar. In various implementations, the carrier gas includes CO₂-lean gas such as O2, H2, N2, He, Ar, CO, or ambient air.

In various implementations of the first example, the acidified seawater flows through the interior volume of the vessel in a first direction, and the carrier gas flows through the interior volume of the vessel in a second direction opposite the first direction.

In various implementations of the first example, the acidified seawater flows through the interior volume of the vessel in a first direction, and the carrier gas flows through the interior volume of the vessel in a second direction orthogonal to the first direction. In such implementations, the acidified seawater is flowed around a plurality of baffles disposed in the interior volume of the vessel. The plurality of baffles defines a plurality of chambers in the interior volume of the vessel such that a direction of flow of the acidified seawater through a chamber of the plurality of chambers is opposite to a direction of flow of the acidified seawater in an adjacent chamber.

In a second example, a system includes a vessel that defines an interior volume. A conduit system is in a top region of the vessel and configured to communicate acidified seawater that includes dissolved CO₂ into the interior volume. A gas diffuser system is disposed in a bottom region of the interior volume of the vessel. The gas diffuser system is configured to bubble carrier gas through the acidified seawater collected in the bottom region, thereby extracting CO₂ from the acidified seawater to form a product gas in the top region. A gas flow controller controls a flow of the carrier gas from an exterior of the vessel into the bottom region through the gas diffuser system. A vacuum pump is configured to pump the product gas from the top region of the vessel.

In various implementations, aspects of the second example include an intake pump that communicates the acidified seawater into the conduit system and a discharge pump that communicates CO₂-lean acidified seawater from the bottom region of the vessel.

In various implementations, aspects of the second example include a booster pump that is coupled to the vacuum pump and configured to pump the product gas away from the top region of the vessel.

In various implementations, aspects of the second example include an acid tank that contains an acidifying agent that lowers a pH of the seawater and a mixer coupled to the acid tank and the conduit system and configure to mix the acidifying agent with the seawater.

In various implementations, aspects of the second example include an output conduit that is coupled to the discharge pump and to the bottom region of the vessel. A alkaline tank that contains an alkaline agent that raises a pH of the acidified seawater. A mixer is coupled to the alkaline tank and configured to mix the alkaline agent with the acidified seawater.

In various implementations, aspects of the second example include a chiller coupled to the vacuum pump and configured to lower a temperature of the product gas so as to induce condensation of water vapor present in the product gas.

In various implementations of the second example, the gas flow controller includes a check valve that allows flow of the carrier gas from the exterior region into the bottom region.

In various implementations of the second example, the product gas comprises water vapor and aspects of the second example include a condenser that is configured to remove the water vapor from the product gas.

In various implementations of the second example, the gas diffuser system includes a diffuser that forms bubbles in the acidified seawater collected in the bottom region.

In various implementations of the second example, the conduit system includes a manifold and a plurality of flow paths that extend from the manifold and are configured to drip the acidified seawater from the top region to the bottom region.

In a third example, a method of operating a degassing system includes communicating acidified seawater that includes dissolved CO₂ into an interior volume of a vessel. The acidified seawater is collected in a bottom region of the interior volume of the vessel. By operation of a gas flow controller, a flow of a carrier gas from an exterior of the vessel into a gas diffuser system in the bottom region is controlled. The carrier gas is bubbled from the gas diffuser system through the acidified seawater collected in the bottom region. By operation of a vacuum pump, the product gas comprising the extracted CO₂ is pumped is pumped from a top region of the vessel.

In various implementations of the third example, the acidified seawater flows through the interior volume of the vessel in a first direction and the carrier gas flows through the interior volume of the vessel in a second direction opposite the first direction.

In various implementations of the third example, the acidified seawater flows through the interior volume of the vessel in a first direction and the carrier gas flows through the interior volume of the vessel in a second direction orthogonal to the first direction. In such implementations, the acidified seawater is flowed around a plurality of baffles disposed in the interior volume of the vessel. The plurality of baffles defines a plurality of chambers in the interior volume of the vessel such that a direction of flow of the acidified seawater through a chamber of the plurality of chambers is opposite to a direction of flow of the acidified seawater in an adjacent chamber.

In various implementations of the third example, the carrier gas extracts at least 80% of the CO₂ from the acidified seawater, and the product gas comprises at least 15% CO₂.

In various implementations of the third example, bubbling the carrier gas through the acidified seawater creates foam in a foam region between the top region and the bottom region in the interior volume of the vessel.

In various implementations of the third example, bubbling the carrier gas through the acidified seawater creates microbubbles in the acidified seawater in a microbubble region between the bottom region and the foam region in the interior volume of the vessel.

In various implementations of the third example, the gas diffuser system includes a gas diffuser disposed in the bottom region.

In various implementations of the third example, the gas diffuser system includes multiple gas diffusers disposed in the bottom region.

In various implementations of the third example, communicating the acidified seawater into the interior volume includes communicating the acidified seawater through a plurality of ports in a conduit system in the top region and introducing the acidified seawater from the top region towards the bottom region.

In various implementations, aspects of the third example may include receiving the input seawater from a seawater intake system. An acid fluid is received from an acid tank. Acidified seawater is formed by mixing the acidic fluid with the input seawater. In various implementations, the acidified seawater has a pH of 6 or less.

In various implementations, aspects of the third example may include receiving CO₂-lean seawater from the interior volume of the vessel. An alkaline fluid is received from an alkaline tank. Product seawater is formed by mixing the alkaline fluid with the CO₂-lean seawater.

In various implementations of the third example, the vacuum pump generates a pressure of 100 mbar to 350 mbar within the vessel.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A method comprising:
in an interior volume of a vessel, receiving acidified seawater comprising dissolved carbon dioxide;
bubbling a carrier gas through the acidified seawater in the interior volume of the vessel, thereby causing the carrier gas to extract at least 80% of the carbon dioxide from the acidified seawater; and
communicating, from the interior volume of the vessel, a product gas comprising the extracted carbon dioxide, the product gas comprising at least 4% carbon dioxide.

2. The method of claim 1, comprising:
collecting the acidified seawater in a bottom region of the interior volume of the vessel;
bubbling the carrier gas through the acidified seawater in the bottom region; and
collecting the product gas in a top region in the interior volume of the vessel, wherein the product gas comprises the extracted carbon dioxide and carrier gas that has bubbled through the acidified seawater.

3. The method of claim 2, wherein:
bubbling the carrier gas through the acidified seawater creates foam in a foam region between the bottom region and the top region in the interior volume of the vessel; and
bubbling the carrier gas through the acidified seawater creates microbubbles in the acidified seawater in a microbubble region between the bottom region and the foam region in the interior volume of the vessel.

4. The method of claim 2, wherein bubbling the carrier gas through the acidified seawater comprises communicating the carrier gas into the bottom region through at least one gas diffuser disposed in the bottom region.

5. The method of claim 2, comprising:
receiving input seawater from a seawater intake system;
receiving an acid fluid from an acid tank;
forming the acidified seawater by mixing the acidic fluid with the input seawater, the acidified seawater having a pH of 6 or less;
wherein receiving the acidified seawater comprises:
communicating the acidified seawater through a plurality of ports in a conduit system in the top region; and
introducing the acidified seawater from the top region to the bottom region.

6. The method of claim 2, comprising:
receiving CO₂-lean acidified seawater from the interior volume of the vessel;
receiving a alkaline fluid from an alkaline tank; and
forming product seawater by mixing the alkaline fluid with the CO₂-lean acidified seawater.

7. The method of claim 2, wherein the carrier gas is communicated from an exterior of the vessel into the bottom region by operation of a blower.

8. The method of claim 2, wherein:
the carrier gas is communicated from an exterior of the vessel into the bottom region due to pressure created in the interior volume by operation of a vacuum pump operating at a pressure in the range of 100 mbar to 350 mbar; and
the product gas, comprising at least 15% carbon dioxide is communicated from the top region to an exterior of the vessel by operation of the vacuum pump.

9. The method of claim 1, wherein the carrier gas is formed from dissolved gas in acidified seawater in the interior volume due to pressure created in the interior volume by operation of a vacuum pump operating at a pressure in the range of 10 mbar to 100 mbar.

10. The method of claim 9, wherein:
the product gas comprising at least 65% carbon dioxide; and
the carrier gas comprises CO₂-lean gas comprising at least one of O₂, H₂, N₂, He, Ar, CO or ambient air.

11. The method of claim 1, wherein the acidified seawater flows through the interior volume of the vessel in a first direction, and the carrier gas flows through the interior volume of the vessel in a second direction opposite the first direction.

12. The method of claim 1, wherein the acidified seawater flows through the interior volume of the vessel in a first direction, and the carrier gas flows through the interior volume of the vessel in a second direction that is perpendicular to the first direction.

13. The method of claim 12, comprising flowing the acidified seawater around a plurality of baffles disposed in the vessel, the plurality of baffles defining a plurality of chambers within the vessel, a direction of flow of the acidified seawater through a chamber of the plurality of chambers being opposite the direction of flow of the acidified seawater in an adjacent chamber.

14. A system comprising:
a vessel that defines an interior volume;
a conduit system in a top region of the interior volume of a vessel, the conduit system configured to communicate acidified seawater comprising dissolved carbon dioxide into the interior volume;
a gas diffuser system in a bottom region of the interior volume of the vessel, the gas diffuser system configured to bubble carrier gas through the acidified seawater collected in the bottom region, thereby extracting carbon dioxide from the acidified seawater to form a product gas in the top region;
a gas flow controller that controls a flow of the carrier gas from an exterior of the vessel into the bottom region through the gas diffuser system; and
a vacuum pump configured to pump the product gas from the top region of the vessel.

15. The system of claim 14, comprising:
a booster pump coupled to the vacuum pump and configured to pump the product gas from the top region of the vessel;
an intake pump that communicates the acidified seawater into the conduit system; and
a discharge pump that communicates CO₂-lean acidified seawater from the bottom region of the vessel.

16. The system of claim 15, comprising:
an acid tank containing an acidifying agent;
a mixer coupled to the acid tank and the conduit system and configured to mix the acidifying agent with the seawater;
an output conduit coupled to the discharge pump and to the bottom region of the vessel;
an alkaline tank containing an alkaline agent; and
a mixer coupled to the alkaline tank and configured to mix the alkaline agent with the acidified seawater.

17. The system of claim 16, comprising a chiller coupled to the vacuum pump and configured to lower a temperature of the product gas so as to induce condensation of water vapor present in the product gas.

18. The system of claim 14, wherein the gas flow controller comprises a check valve that allows flow of the carrier gas from the exterior region of the vessel into the bottom region.

19. The system of claim 14, wherein the product gas comprises water vapor and the system comprises a condenser configured to remove the water vapor from the product gas.

20. The system of claim 14, wherein the gas diffuser system comprises a diffuser that forms bubbles in the acidified seawater collected in the bottom region.

21. The system of claim 14, wherein the conduit system comprises a manifold and a plurality of flow paths extending from the manifold and configured to drip the acidified seawater from the top region into the bottom region.

22. A method of operating a degassing system comprising a vessel, the method comprising:
communicating acidified seawater comprising dissolved carbon dioxide into an interior volume of the vessel;
collecting the acidified seawater in a bottom region of the interior volume of the vessel;
controlling flow of a carrier gas from an exterior of the vessel into a gas diffuser system in the bottom region;
bubbling the carrier gas from the gas diffuser system through the acidified seawater collected in the bottom region; and
by operation of a vacuum pump, pumping product gas comprising the extracted carbon dioxide from a top region of the vessel.

23. The method of claim 22, wherein the acidified seawater flows through the interior volume of the vessel in a first direction, and the carrier gas flows through the interior volume of the vessel in a second direction opposite the first direction.

24. The method of claim 22, wherein the acidified seawater flows through the interior volume of the vessel in a first direction, and the carrier gas flows through the interior volume of the vessel in a second direction that is perpendicular to the first direction.

25. The method of claim 24, comprising flowing the acidified seawater around a plurality of baffles disposed in the vessel, the plurality of baffles defining a plurality of chambers within the vessel, a direction of flow of the acidified seawater through a chamber of the plurality of chambers being opposite the direction of flow of the acidified seawater in an adjacent chamber.

26. The method of claim 22, wherein the carrier gas extracts at least 80% of the carbon dioxide from the acidified seawater, and the product gas comprises at least 15% carbon dioxide.

27. The method of claim 22, wherein:
bubbling the carrier gas through the acidified seawater creates foam in a foam region between the bottom region and the top region in the interior volume of the vessel; and
bubbling the carrier gas through the acidified seawater creates microbubbles in the acidified seawater in a microbubble region between the bottom region and the foam region in the interior volume of the vessel.

28. The method of claim 22, wherein the gas diffuser system comprises at least one gas diffuser disposed in the bottom region.

29. The method of claim 22, comprising:
receiving input seawater from a seawater intake system;
receiving an acid fluid from an acid tank;
forming the acidified seawater by mixing the acidic fluid with the input seawater; and
communicating the acidified seawater from an exterior of the vessel into the conduit system;
wherein communicating the acidified seater into the interior volume comprises:
communicating the acidified seawater through a plurality of ports in the conduit system in the top region; and
introducing the acidified seawater from the top region toward the bottom region.

30. The method of claim 22, comprising:
receiving CO₂-lean acidified seawater from the interior volume of the vessel;
receiving a alkaline fluid from a alkaline tank; and
forming product seawater by mixing the alkaline fluid with the CO₂-lean acidified seawater.

31. The method of claim 22, wherein the vacuum pump generates a pressure of 100 mbar to 350 mbar within the vessel.
